(19) United States
(12) Patent Application Publication
(10) Pub. No.: US 2018/0227199 A1
(43) Pub. Date: Aug. 9, 2018

(54) IOT DEVICE FOG NETWORKING OPERATION

(71) Applicant: Aerohive Networks, Inc., Milpitas, CA (US)

(72) Inventors: Changming Liu, Cupertino, CA (US); Junjie Ma, San Jose, CA (US); Yufeng Wu, Milpitas, CA (US); Chris Scheers, Palo Alto, CA (US)

(73) Assignee: Aerohive Networks, Inc., Milpitas, CA (US)

(21) Appl. No.: 15/428,049

(22) Filed: Feb. 8, 2017

(51) Int. Cl. H04L 12/26; H04L 29/08

(52) U.S. Cl. CPC H04L 43/065; H04W 84/12; H04L 67/12; H04L 67/1002

(57) ABSTRACT

Device analytics at a local infrastructure network using fog networking techniques is disclosed. A specific implementation includes a fog networking-based Internet of Things (“IoT”) device analytics subsystem and multi-protocol infrastructure network devices. An example of operation includes analyzing IoT device data through fog networking at a local infrastructure network device and performing load balancing across network devices for analyzing IoT device data through fog networking.

### BRIEF DESCRIPTION OF THE DRAWINGS

FIG. 1 depicts a diagram of an example of a system for generating IoT device analytics at a local infrastructure network device using fog networking.

FIG. 2 depicts a flowchart of an example of a method for analyzing IoT device data at local infrastructure network devices using fog networking.

FIG. 3 depicts a diagram of an example of a system for performing load balancing across local infrastructure network devices for purposes of analyzing IoT device data through fog networking.

FIG. 4 depicts a flowchart of an example of a method for performing load balancing between local infrastructure network devices for purposes of analyzing IoT device data through fog networking.

FIG. 5 depicts a diagram of an example of a local IoT device analytics system 502.

FIG. 6 depicts a flowchart of an example of a method for analyzing IoT device data through fog networking at a local infrastructure network device.

FIG. 7 depicts a diagram of an example of a system for analyzing IoT device data generated by an IoT camera device through fog networking.

FIG. 8 depicts a flowchart of an example of a method for analyzing camera data at a local infrastructure network device through fog networking.

### DETAILED DESCRIPTION

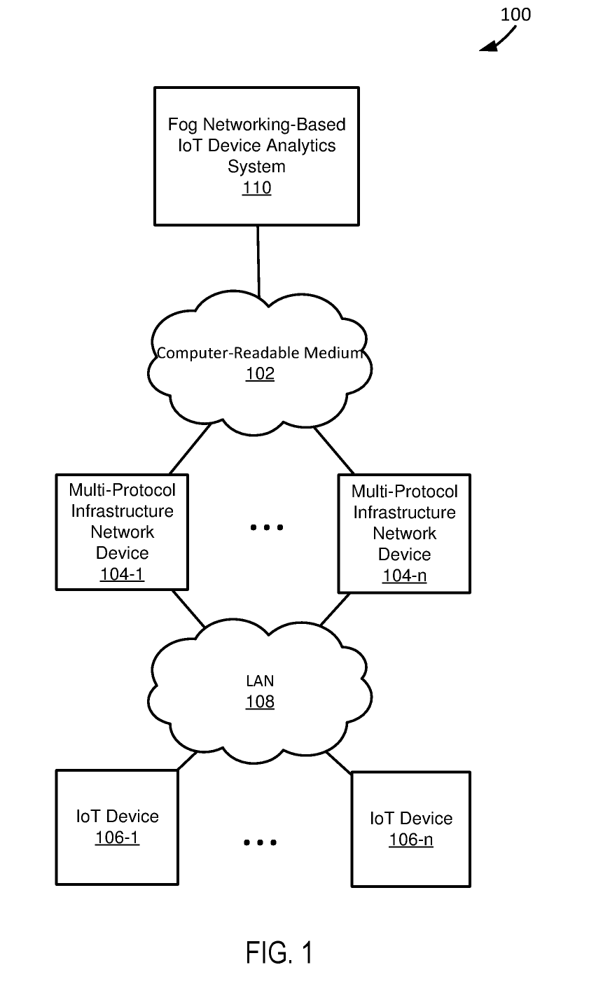

FIG. 1 depicts a diagram 100 of an example of a system for generating Internet of Things (hereinafter referred to as “IoT”) device analytics at a local infrastructure network device using fog networking. The system of the example of FIG. 1 includes a computer-readable medium 102, multi-protocol infrastructure network device 104-1 . . . multi-protocol infrastructure network device 104-n (hereinafter referred to as “multi-protocol infrastructure network devices 104”), IoT device 106-1 . . . IoT device 106-n (hereinafter referred to as “IoT devices 106”), a local area network 108 (hereinafter referred to as “LAN 108”, and a fog networking-based IoT device analytics system 110. In the example system shown in FIG. 1, the IoT devices 106 are operationally coupled to the multi-protocol infrastructure network devices 104 through the LAN 108. While LAN 108 is shown as only one local area network, LAN 108 can include a plurality of separate LANs which operationally couple the IoT devices 106 to the multi-protocol infrastructure network devices 104.

The computer-readable medium 102 and other computer readable mediums discussed in this paper are intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 and other computer readable mediums discussed in this paper are intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

Assuming a computer-readable medium includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (hereinafter referred to as “HTTP”) for hypertext markup language (hereinafter referred to as “HTML”) documents that make up the World Wide Web (hereinafter referred to as “the web”). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

The devices, systems, and computer-readable mediums described in this paper can be implemented as a computer system or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. As used in this paper, edge devices include applicable devices at an edge of one or a combination of a LAN, a WLAN, a consumer network, and an enterprise network. For example, an edge device can be a networking device, at an edge of a LAN, providing wireless access to network services through a WLAN. In another example, an edge device can be an IoT device accessing network services through a LAN. In yet another example, an edge device can be an IoT device transmitting data through at least a portion of a wired connection, e.g. a Universal Serial Bus (hereinafter referred to as “USB”) connection. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. That is, the engine includes hardware. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

Cloud computing is a type of WAN-based computing that provides shared computer processing resources and data to computers and other devices on demand. It is a model for enabling ubiquitous, on-demand access to a shared pool of configurable computing resources (e.g., computer networks, servers, storage, applications, and services), which can be rapidly provisioned and released with minimal management effort. Cloud computing and storage solutions provide users and enterprises with various capabilities to store and process their data in either privately owned, or third-party data centers that may be located far from the user-ranging in distance from across a city to across the world. Cloud computing relies on sharing of resources to achieve coherence and economy of scale, similar to a utility (like the electricity grid) over an electricity network.

Returning to the example system shown in FIG. 1, the multi-protocol infrastructure network devices 104 are intended to represent devices that send and receive data used in providing access to network services of a network. For example, the multi-protocol infrastructure network devices 104 can provide IoT devices network service access through a LAN. In a specific implementation, the multi-protocol infrastructure network devices 104 receive signals from an IoT device to which the multi-protocol infrastructure network devices 104 may or may not (depending upon implementation-, configuration-, network-, or device-specific considerations) provide access to network services. In another implementation, the multi-protocol infrastructure network devices 104 send signals to an IoT device to which the multi-protocol infrastructure network devices 104 may or may not (depending upon implementation-, configuration-, network-, or device-specific considerations) provide access to network services.

The multi-protocol infrastructure network devices 104 and other network devices described in this paper include or function as routers, switches, access points, gateways, including wireless gateways, repeaters, a combination thereof, or other applicable devices. In functioning as gateways, the multi-protocol infrastructure network devices 104 can transmit and receive data between a WAN through a LAN back-end and IoT devices coupled to the multi-protocol infrastructure network devices 104. In functioning as access points, the multi-protocol infrastructure network devices 104 can couple an IoT device to a network device forming a LAN back-end and subsequently a WAN through a LAN. For example, the multi-protocol infrastructure network devices 104 can be used to route data between IoT devices coupled to the multi-protocol infrastructure network devices 104 as part of a personal area network (hereinafter referred to as “PAN”) formed, at least in part, by the IoT devices and the multi-protocol infrastructure network devices 104.

In a specific implementation, the multi-protocol infrastructure network devices 104 can function according to applicable wireless communication protocols or standards, e.g. Wi-Fi, ZigBee®, Bluetooth®, applicable low-power communication standards, or applicable wireless PAN communication standards. For example, the multi-protocol infrastructure network devices 104 can be wirelessly coupled to IoT devices through wireless connections established according to a Wi-Fi protocol and subsequently communicate with the IoT devices over the wireless connections according to the Wi-Fi protocol. In another example, the multi-protocol infrastructure network devices 104 can be wirelessly coupled to IoT devices through wireless connections established according to a Bluetooth® protocol and subsequently communicate with the IoT devices over the wireless connections according to the Bluetooth® protocol.

In a specific implementation, the multi-protocol infrastructure network devices 104 function to communicate with IoT devices over a wired connection. Specifically, the multi-protocol infrastructure network devices 104 can be coupled to IoT devices through applicable wired connections and communicate with the IoT devices through the wired connections. For example, the multi-protocol infrastructure network devices 104 can be coupled to an IoT device through a USB connection and receive data generated at the IoT device over the USB connection.

The multi-protocol infrastructure network devices 104 are intended to represent infrastructure network devices capable of providing IoT devices access to network services through wired and wireless connections established and maintained according to different protocols, thereby forming different LANs, e.g. different WLANs. For example, the multi-protocol infrastructure network devices 104 can provide network service access to a first IoT device through a Bluetooth® connection and provide network service access to a second IoT device through a Wi-Fi connection. Additionally, the multi-protocol infrastructure network devices 104 can simultaneously provide multiple IoT devices access to network services of a network over different wired or wireless connections. For example, the multi-protocol infrastructure network devices 104 can provide network service access to a first IoT device through a Bluetooth® connection and simultaneously provide network service access to a second IoT device through a Wi-Fi connection.

In allowing IoT devices to access network services through different LANs, the multi-protocol infrastructure network devices 104 allows IoT devices configured to access network services through the different LANs to communicate with each other over the different LANs. For example, a first IoT device can send data to a unique multi-protocol infrastructure network device through a Bluetooth® based WLAN, and the same or a different unique multi-protocol infrastructure network device can send the data to a second IoT device through a ZigBee® based WLAN. As a result, the first and second IoT devices can communicate with each other even though the first IoT device is configured to access network services through a Bluetooth® based WLAN and the second IoT device is configured to access network services through a ZigBee® based WLAN. Data can be translated or transformed for transmission according to a different protocol, e.g. from a Wi-Fi connected device to a ZigBee® connected device, at an applicable network device within a LAN, e.g. at the multi-protocol infrastructure network devices 104, a fog networking-based system, or a cloud-based system.

Fog networking, also known as “fogging,” is an architecture that uses one or more collaborative multitude of end-user clients or near-user edge devices to carry out a substantial amount of storage (rather than primarily in cloud data centers), communication (rather than routed over a WAN backbone), control, configuration, measurement, and management (rather than controlled primarily by network gateways). In the examples discussed in this paper, some of the storage, communication, and management are carried out on the multi-protocol infrastructure network devices 104, the relevant LAN, and/or the enterprise network of which the resources are a part.

The multi-protocol infrastructure network devices 104 function as infrastructure devices by being formed as part of a local network infrastructure for providing network service access through LANs. For example, the multi-protocol infrastructure network devices 104 can be forwarding devices of a LAN network infrastructure and used to form, at least in part, a network back-end. In another example, the multi-protocol infrastructure network devices 104 can be edge devices of a LAN network infrastructure and used to form, at least in part, a ZigBee® network or a Wi-Fi network.

In a specific implementation, the multi-protocol infrastructure network devices 104 include protocol-compatible or protocol-specific hardware used in establishing and maintaining a LAN according to a specific protocol. For example, the multi-protocol infrastructure network devices 104 can include ZigBee® interfaces configured to allow the multi-protocol infrastructure network devices 104 to establish and maintain ZigBee® based WLANs. Further in the example, the multi-protocol infrastructure network devices 104 can include ZigBee® interfaces included as part of removable dongles coupled to the multi-protocol infrastructure network devices 104 or included as part of fixed hardware integrated into the multi-protocol infrastructure network devices 104. In another example, the multi-protocol infrastructure network devices 104 include hardware used in providing network service access through a Wi-Fi WLAN. In yet another example, the multi-protocol infrastructure network devices 104 include a USB interface that allows an IoT device to be coupled to the multi-protocol infrastructure network devices 104 through the USB interface, thereby forming, at least part of, a LAN.

In a specific implementation, the multi-protocol infrastructure network devices 104 function as direct portals to a LAN back-end. In functioning as direct portals to a LAN back-end the multi-protocol infrastructure network devices 104 are directly connected to a network switch, e.g. a router or a bridge, of a LAN back-end. The multi-protocol infrastructure network devices 104 can each be directly connected to corresponding individual network switches of a LAN back-end or a plurality of the multi-protocol infrastructure network devices 104 can be directly connected to a single network switch of the LAN back-end. A LAN back-end to which the multi-protocol infrastructure network devices 104 are coupled can be formed through either or both a combination of a wired or wireless back-end.

In a specific implementation, in serving as direct portals to a LAN back-end, a single device of the multi-protocol infrastructure network devices 104 can provide direct access to network services of a network, without having to exchange data with other devices at the edge of a LAN, e.g. other multi-protocol infrastructure network devices 104. For example, if an IoT device is coupled to a multi-protocol infrastructure network device through a ZigBee® connection as part of a ZigBee® network, data can be exchanged between the IoT device and a LAN back-end using the multi-protocol infrastructure network device without having to exchange the data with another multi-protocol infrastructure network device or IoT device forming a node as part of the ZigBee® network. By providing direct access to a LAN back-end, without exchanging data from other edge devices, power consumption levels of the other edge devices can be reduced and/or network traffic on the other edge devices can be reduced leading to increased network throughput.

In a specific implementation, the multi-protocol infrastructure network devices 104 are directly interconnected edge devices of a LAN. Directly interconnected edge devices are edge devices that are directly connected to each other independently from couplings provided through a LAN back-end. Specifically, the multi-protocol infrastructure network devices 104 can be coupled to each other through wireless connections along the edge of the LAN and outside of a LAN back-end. The multi-protocol infrastructure network devices 104 can exchange data directly between each other, without the use of a LAN back-end, through wired or wireless connections formed between the multi-protocol infrastructure network devices 104. In being directly interconnected edge devices, the multi-protocol infrastructure network devices 104 can communicate with each other when a LAN back-end and/or a WAN. The multi-protocol infrastructure network devices 104 can use connections directly interconnecting the multi-protocol infrastructure network devices 104 to manage IoT devices through LANs. For example, in being directly interconnected edge devices, the multi-protocol infrastructure network devices 104 can locally exchange data between IoT devices, as part of enforcing an IoT policy, when a WAN fails and Internet access is disrupted using, at least in part, wired or wireless connections directly connecting the multi-protocol infrastructure network devices 104 together independently from a LAN back-end.

In a specific implementation, as part of IoT device management, the multi-protocol infrastructure network devices 104 function to locally control IoT devices through LANs. The multi-protocol infrastructure network devices 104 can control an IoT device according to an IoT policy. For example an IoT policy can specify to shut off a camera at a specific time, and the multi-protocol infrastructure network devices 104 can instruct the camera to shut off according to the IoT policy using LANs at the specific time. Additionally, the multi-protocol infrastructure network devices 104 can control an IoT device according to instructions from a user. For example, if a user checks a status of the lights in their office, e.g. by viewing published IoT device data, and instructs to turn the lights off, through the LAN, then the multi-protocol infrastructure network devices 104 can instruct the lights to shut off according to the instructions received from the user.

The functions and data received and generated by the functioning of the multi-protocol infrastructure network devices 104 is capable of being distributed across multiple multi-protocol infrastructure network devices 104 or performed by a single multi-local protocol infrastructure network device. For example, a single multi-protocol infrastructure network device can be configured to receive data from an IoT device and update an IoT policy accordingly for use by other multi-protocol infrastructure network devices. In another example, a plurality of multi-local protocol infrastructure network devices can maintain traffic pattern records of IoT devices for use in maintaining an IoT policy.

Returning back to the example system shown in FIG. 1, the IoT devices 106 are intended to represent devices that function to access network services of an enterprise or consumer network through a LAN. In accessing network services, the IoT devices 106 can use a LAN to either or both send and receive data. For example, the IoT devices 106 can use a WLAN to either or both send and receive data. Depending upon implementation-specific or other considerations, the IoT devices 106 can use a LAN to communicate with other IoT devices or sources or systems through a WAN. The IoT devices 106 can include wired and wireless interfaces through which the IoT devices 106 can send and receive data over wired and wireless connections. Examples of IoT devices include thermostats, mobile devices, biological managers, sensory devices, and functionality performing devices. In sending and receiving data over a wireless connection, the IoT devices 106 can communicate according to an applicable wireless communication protocol or standard, e.g. Wi-Fi, ZigBee®, Bluetooth®, Z-Wave®, applicable low-power communication standards, or applicable wireless PAN communication standards. For example, the IoT devices 106 can send and receive data over a ZigBee® WLAN defined by IEEE 802.15-4, which is hereby incorporated by reference. The IoT devices 106 can include unique identifiers which can be used to facilitate network service access by the IoT devices 106.

In a specific implementation, the IoT devices 106 act as or include stations, by including a wireless interface through which the IoT devices 106 can be coupled through Wi-Fi connections to a multi-protocol infrastructure network device. A station, as used in this paper, can be referred to as a device with a media access control (MAC) address and a physical layer (PHY) interface to a wireless medium that complies with the IEEE 802.11 standard. Thus, for example, the IoT devices 106 can be referred to as a station, if applicable. IEEE 802.11a-1999, IEEE 802.11b-1999, IEEE 802.11g-2003, IEEE 802.11-2007, IEEE 802.11n TGn Draft 8.0 (2009), and IEEE 802.11ac-2013 are incorporated by reference. As used in this paper, a system that is 802.11 standards-compatible or 802.11 standards-compliant complies with at least some of one or more of the incorporated documents' requirements and/or recommendations, or requirements and/or recommendations from earlier drafts of the documents, and includes Wi-Fi systems. Wi-Fi is a non-technical description that is generally correlated with the IEEE 802.11 standards, as well as Wi-Fi Protected Access (WPA) and WPA2 security standards, and the Extensible Authentication Protocol (EAP) standard. In alternative implementations, a station may comply with a different standard than Wi-Fi or IEEE 802.11, may be referred to as something other than a “station,” and may have different interfaces to a wireless or other medium.

IEEE 802.3 is a working group and a collection of IEEE standards produced by the working group defining the physical layer and data link layer's MAC of wired Ethernet. This is generally a LAN technology with some wide area network applications. Physical connections are typically made between nodes and/or network devices, e.g. infrastructure network devices (hubs, switches, routers), by various types of copper or fiber cable. IEEE 802.3 is a technology that supports the IEEE 802.1 network architecture. As is well-known in the relevant art, IEEE 802.11 is a working group and collection of standards for implementing WLAN computer communication in the 2.4, 3.6 and 5 GHz frequency bands. The base version of the standard IEEE 802.11-2007 has had subsequent amendments. These standards provide the basis for wireless network products using the Wi-Fi brand. IEEE 802.1 and 802.3 are incorporated by reference.

In a specific implementation, the IoT devices 106 function to only send data generated at the IoT devices 106. In only sending data generated at the IoT devices 106, the IoT devices 106 can function to access network services of a network provided through a LAN using multi-protocol infrastructure network device. For example, the IoT devices 106 can include beacons configured to transmit beacon signals.

In a specific implementation, the IoT devices 106 include or are otherwise coupled to a media capturing device. A media capturing device includes an applicable device for capturing media. Media includes applicable content capable of being perceived by a human. For example, media can include a video feed. An example of a media capturing device includes a camera. A camera serving as one of the IoT devices 106 can be coupled to a multi-protocol infrastructure network device through either or both a wired or wireless connection. For example, a camera serving as one of the IoT devices 106 can be coupled to a multi-protocol infrastructure network device through a Wi-Fi-based wireless connection. In another example, a camera serving as one of the IoT devices 106 can be coupled to a multi-protocol infrastructure network device through a wired connection formed through a USB connection between the camera and the multi-protocol infrastructure network device.

Referring back to the example system shown in FIG. 1, the LAN 108 is intended to represent a network that provides wired or wireless communication channels through which IoT devices can access network services of a network, e.g. an enterprise or consumer network. The LAN 108 can be established and maintained according to applicable wired or wireless communication protocols or standards, e.g. Wi-Fi, ZigBee®, Bluetooth®, applicable low-power communication standards, or applicable wired or wireless PAN communication standards. The LAN 108 can be used to transmit signals to and from IoT devices as part of the devices accessing network services through a multi-protocol infrastructure network device.

In the example, of FIG. 1, the LAN 108 includes a computer-readable medium, but is differentiated from the computer-readable medium 102 to illustrate the bifurcation of the medium by the multi-protocol infrastructure network devices 104. While the LAN 108 is shown to represent only a single LAN, it can represent a plurality of different LANs, potentially established and maintained according to different standards. For example the LAN 108 can include a ZigBee® based WLAN maintained simultaneously with a Wi-Fi based WLAN.

In a specific implementation, the LAN 108 is used to transmit IoT device data from an IoT device to an applicable device for providing the IoT device access to network services, such as the multi-protocol infrastructure network devices described in this paper. IoT device data includes applicable data generated at an IoT device. For example, IoT device data can include images or a feed of captured images forming video generated at a camera. Further in the example, the LAN 108 can be formed through a USB connection and used to transmit the captured images or the feed of captured images from the camera to an applicable device for providing the camera access to network services, such as the multi-protocol infrastructure network devices described in this paper.

Referring back to the example system shown in FIG. 1, the fog networking-based IoT device analytics system 110 is intended to represent a system that functions to analyze IoT device data through fog networking. In analyzing IoT device data through fog networking, the fog networking-based IoT device analytics system 110 generates IoT device analytics data based on analysis of the IoT device data. IoT device analytics data generated by the fog networking-based IoT device analytics system 110 includes applicable data generated as part of analyzing IoT device data generated by IoT devices. For example, IoT device analytics data can include portions of IoT device data generated at IoT devices, pre-processed IoT device data generated at IoT devices, patterns recognized from IoT device data generated at IoT devices, and applicable conclusions or inferences reached through analysis of IoT device data generated at IoT devices. In a further example, IoT device analytics data can include traffic patterns of people in a store as determined from video feeds received from one or a plurality of cameras in the store.

The fog networking-based IoT device analytics system 110 is fog networking-based in that it analyzes IoT device data through fog networking using applicable devices forming part of a local network infrastructure of one or a combination of a LAN, a WLAN, a consumer network, and an enterprise network, hereinafter referred to as local infrastructure network devices. For example, the IoT device analytics system 110 can use a network device functioning as an access point or a router in a LAN to analyze IoT device data through fog networking. In analyzing IoT device data using local infrastructure network devices, the fog networking-based IoT device analytics system 110 can be implemented, at least in part, at one or a combination of local infrastructure network devices. For example, the fog networking-based IoT device analytics system 110 can be implemented at an applicable edge device for providing IoT devices access to network services through a LAN, such as the multi-protocol infrastructure network devices described in this paper. Further, in analyzing IoT device data using local infrastructure network devices, the fog networking-based IoT device analytics system 110 can analyze the IoT device data to generate IoT device analytics data at the local infrastructure network devices. For example, the fog networking-based IoT device analytics system 110 can analyze IoT device data to generate IoT device analytics data at a plurality of applicable edge devices for providing IoT devices access to network services through a LAN, such as the multi-protocol infrastructure network devices described in this paper.

In a specific implementation, the fog networking-based IoT device analytics system 110 analyzes IoT device data generated and received from a camera. For example, the fog networking-based IoT device analytics system 110 can analyze a video feed of a camera in a store to determine traffic patterns of consumers in the store and subsequently generate IoT device analytics data indicating the determined traffic patterns. The fog networking-based IoT device analytics system 110 can analyze IoT device data generated and received from a camera through fog networking. In analyzing IoT device data generate and received from a camera through fog networking, the fog networking-based IoT device analytics system 110 can analyze the IoT device data at local infrastructure network devices. For example, the fog networking-based IoT device analytics system 110 can analyze a video feed captured and received from a camera at local infrastructure network devices. Further in the example, the fog networking-based IoT device analytics system 110 can analyze the video feed captured and received from the camera at an applicable edge device forming part of a local network infrastructure and used in providing the camera access to network services, such as the multi-protocol infrastructure network devices described in this paper.

In a specific implementation, the fog networking-based IoT device analytics system 110 is fog networking-based in that it provides generated IoT device analytics data to an applicable remote system, e.g. a cloud-based system, through a WAN as part of analyzing IoT device data through fog networking. A remote system, as used in this paper, includes an applicable system or device outside of a LAN. For example, the fog networking-based IoT device analytics system 110 can generate IoT device analytics data from received IoT device data, and subsequently provide the IoT device analytics data to a remote server through a WAN. Further in the example, a user can access the IoT device analytics data at the remote server through the WAN or the Internet.

In a specific implementation, the fog networking-based IoT device analytics system 110 is fog networking-based in that it selectively provides specific portions of received IoT device data to an applicable remote system, e.g. a cloud-based system, through a WAN as part of analyzing IoT device data through fog networking. For example, the fog networking-based IoT device analytics system 110 can selectively chose to provide specific portions of a received video feed to a remote server through a WAN. Further in the example, a user can access the specific portions of the received video feed at the remote server through the WAN or the Internet.

In a specific implementation, the fog networking-based IoT device analytics system 110 functions to transmit either or both IoT device analytics data and selected portions of received IoT device data to a remote system according to an applicable data transport or messaging protocol. Specifically, the fog networking-based IoT device analytics system 110 can transmit either or both IoT device analytics data and selected portions of received IoT device data using an applicable lightweight message protocol. For example, the fog networking-based IoT device analytics system 110 can transmit either or both IoT device analytics data and selected portions of received IoT device data according to an MQ Telemetry Transport (hereinafter referred to as “MQTT”) protocol. It may be noted the “MQ” of “MQTT” came from IBM's MQ Series message queuing product line, but queuing is not required to be supported as a standard feature in all situations. The MQTT International Organization for Standardization (“ISO”) standard (ISO/IEC PRF 20922) is incorporated by reference.

In a specific implementation, in analyzing IoT device data through fog network, the fog networking-based IoT device analytics system 110 functions to selectively refrain from providing all or specific portions of the IoT device data to an applicable remote system through a WAN. For example, the fog networking-based IoT device analytics system 110 can selectively provide portions of raw video captured by a camera along with IoT device analytics data generated from all of the raw video captured by the camera. In selectively refraining from providing all or specific portions of IoT device data to a remote system through a WAN as part of analyzing the IoT device data through fog networking, the fog networking-based IoT device analytics system 110 can reduce traffic through an applicable network used or potentially used to transmit the IoT device data to the remote system. For example, the fog networking-based IoT device analytics system 110 can reduce traffic through an enterprise WAN network used to communicate with a remote system. In turn, this can reduce latency and an amount of consumer bandwidth or consumed network resources of one or a combination of a LAN, a WLAN, a consumer network, or an enterprise network.

In a specific implementation, the fog networking-based IoT device analytics system 110 functions to manage selective local storage of either or both received IoT device data and generated IoT device analytics data. The fog networking-based IoT device analytics system 110 can manage selective local storage of either or both received IoT device data and generated IoT device analytics data as part of analyzing IoT device data through fog networking. Local storage of data, as used in this paper, includes storage of data locally at local infrastructure network devices. For example, the fog networking-based IoT device analytics system 110 can manage selective local storage of either or both received IoT device data and generated IoT device analytics data at local infrastructure network devices. The fog networking-based IoT device analytics system 110 can manage selective local storage of either or both received IoT device data and generated IoT device analytics data, as part of load balancing across local infrastructure network devices in analyzing IoT device data through fog networking.

In a specific implementation, in managing local storage of either or both received IoT device data and generated IoT device analytics data, the fog networking-based IoT device analytics system 110 functions to select specific data to store locally. For example, the fog networking-based IoT device analytics system 110 can select to store IoT device data locally if it was used to generate IoT device analytics data or useful IoT device analytics data. Further, the fog networking-based IoT device analytics system 110 can cause selected IoT device data and generated IoT device analytics data to actually be stored locally at devices within a network infrastructure in managing local storage of data. In selecting data of either or both IoT device data and IoT device analytics data to store locally, the fog networking-based IoT device analytics system 110 can select data to store locally based on available storage capacities at device within a network. For example, the fog networking-based IoT device analytics system 110 can select IoT device data and IoT device analytics data to store locally based on storage capacities at local infrastructure network devices.

In a specific implementation, in managing local storage of either or both received IoT device data and generated IoT device analytics data, the fog networking-based IoT device analytics system 110 functions to select specific data to remove from local storage. For example, the fog networking-based IoT device analytics system 110 can select to delete locally stored IoT device data if it was not used to generate IoT device analytics data or useful IoT device analytics data. Further, the fog networking-based IoT device analytics system 110 can cause selected IoT device data and generated IoT device analytics data to actually be removed from local storage at devices within a network infrastructure in managing local storage of data. In selecting data of either or both IoT device data and IoT device analytics data to delete from local storage, the fog networking-based IoT device analytics system 110 can select data to remove from local storage based on available storage capacities at device within a network. For example, the fog networking-based IoT device analytics system 110 can select IoT device data and IoT device analytics data to delete from local storage based on storage capacities at local infrastructure network devices.

In a specific implementation, the fog networking-based IoT device analytics system 110 functions to perform load balancing across applicable devices used in analyzing IoT device data through fog networking. Specifically, the fog networking-based IoT device analytics system 110 can perform local balancing across local infrastructure network devices used in analyzing IoT device data through fog networking. The fog networking-based IoT device analytics system 110 can perform load balancing across local infrastructure network devices for purposes of analyzing IoT device data through fog networking. For example, the fog networking-based IoT device analytics system 110 can cause either or both IoT device data and IoT device analytics data received at a first local infrastructure network device to be sent from the first local infrastructure network device to a second local infrastructure network device for purposes of analyzing the IoT device data at the second local infrastructure network device. Further in the example, the fog networking-based IoT device analytics system can use the second local infrastructure network device or cause the second local infrastructure network device to analyze the IoT device data to generate IoT device analytics data. In the example, the fog networking-based IoT device analytics system can use or cause the second local infrastructure network device to provide either or both the IoT device analytics data and portions of the IoT device data to a remote system as part of analyzing IoT device data through fog networking.

In a specific implementation, the fog networking-based IoT device analytics system 110 functions to perform load balancing for purposes of analyzing IoT device data through fog networking based on factors related to providing IoT devices network service access through local infrastructure network devices. Factors related to providing IoT devices network service access through local infrastructure network devices include applicable factors related to providing network service access to IoT devices through local infrastructure network device. Examples of factors related to providing IoT devices network service access through local infrastructure network devices include an amount of available computational resources at a local infrastructure network device, an amount of local storage available at a local infrastructure network device, a number of IoT devices a local infrastructure network device is providing access to network services, an amount of computational resources being used at a local infrastructure network device in providing IoT devices access to network services, and an amount of computational resources being used at other local infrastructure network devices in providing IoT devices access to network services. For example, if a local infrastructure network device lacks available computational resources to analyze IoT device data through fog networking, then the fog networking-based IoT device analytics system 110 can cause the local infrastructure network device to send the IoT device data to another local infrastructure network device for purposes of analyzing the IoT device data at the another device through fog networking.

In a specific implementation, the fog networking-based IoT device analytics system 110 functions to perform load balancing for purposes of analyzing IoT device data through fog networking based on factors related to analyzing IoT device data. Factors related to analyzing IoT device data include applicable factors related to analyzing IoT device data through fog networking. Examples of factors related to analyzing IoT device data include whether a local infrastructure network device is assigned as a central IoT device data analysis device, an amount of computational resources being used at a local infrastructure network device in analyzing IoT device data through fog networking, and computational resources being used by other local infrastructure network devices in analyzing IoT device data through fog networking. For example, if a specific local infrastructure network device is designated as a central IoT data analysis device for purposes of analyzing IoT device data, then the fog networking-based IoT device analytics system 110 can cause other local infrastructure network devices to provide receive IoT device data to the specific local infrastructure network device for analysis of the data through fog networking.

In a specific implementation, the fog networking-based IoT device analytics system 110 functions to perform load balancing across local infrastructure network devices for purposes of managing local storage of either or both IoT device data and IoT device analytics data at the local infrastructure network devices. For example, the fog networking-based IoT device analytics system 110 can cause a first local infrastructure network device to send received IoT device data to a second local infrastructure network device for storage at the second local infrastructure network device. The fog networking-based IoT device analytics system 110 can perform load balancing across local infrastructure network devices for purposes of managing local storage of data based on amounts of available storage at the local infrastructure network devices. For example, if a first local infrastructure network device receives IoT device data and does not have capacity to store the IoT device data locally, then the fog network-based IoT device analytics system 110 can cause the first local infrastructure network device to send the IoT device data to a second local infrastructure network device for purposes of locally storing the IoT device data at the second local infrastructure network device.

In a specific implementation, the fog networking-based IoT device analytics system 110 functions to configure an IoT device through a LAN connecting the IoT device to an applicable local infrastructure network device, such as the multi-protocol infrastructure network devices described in this paper. In configuring an IoT device, the fog networking-based IoT device analytics system 110 can configure an IoT device to refrain from performing any pre-processing of IoT device data generated by the IoT device. Further, in configuring an IoT device, the fog networking-based IoT device analytics system 110 can configure an IoT device to refrain from analyzing IoT device data at the IoT device, thereby reducing an amount of data the IoT device has to send and reducing an amount of computational resources the IoT device has to utilize in normal functioning.

In an example of operation of the example system shown in FIG. 1, the IoT devices 106 generate IoT device data and provide the IoT device data to the multi-protocol infrastructure network devices 104 through the LAN 108. In the example of operation of the example system shown in FIG. 1, the IoT devices 106 provide the IoT device data to the multi-protocol infrastructure network devices 104 through either a wired or wireless connection formed as at least part of the LAN 108. Further, in the example of operation of the example system shown in FIG. 1, the fog networking-based IoT device analytics system 110 performs load balancing across the multi-protocol infrastructure network devices 104 for purposes of using fog networking to analyze the IoT device data received from the IoT devices 106.

In the example of operation of the example system shown in FIG. 1, the fog networking-based IoT device analytics system 110 analyzes the IoT device data to generate IoT device analytics data at the multi-protocol infrastructure network devices 104 in performing load balancing across the multi-protocol infrastructure network devices 104 for the purposes of using fog networking to analyze the IoT device data received from the IoT devices 106. Additionally, in the example of operation of the example system shown in FIG. 1, the fog networking-based IoT device analytics system 110 provides the IoT device analytics data generated at the multi-protocol infrastructure network devices to a remote system as part of analyzing the IoT device data through fog networking.

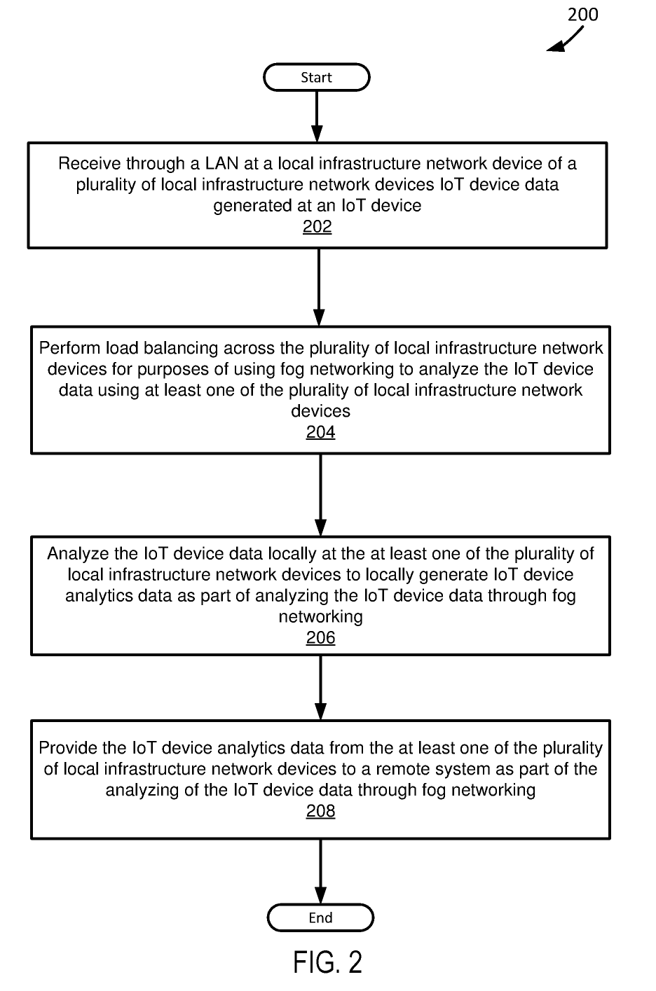

FIG. 2 depicts a flowchart 200 of an example of a method for analyzing IoT device data at local infrastructure network devices using fog networking. The flowchart 200 begins at module 202, where IoT device data generated at an IoT device is received at a local infrastructure network device of a plurality of local infrastructure network devices through a LAN. A local infrastructure network device of a plurality of local infrastructure network devices can include an edge device or a forwarding device forming a local network infrastructure of one or a combination of a LAN, a WLAN, a consumer network, and an enterprise network. For example, a local infrastructure network device of a plurality of local infrastructure network devices configured to receive IoT device generated at an IoT device can include an applicable device for providing the IoT device access to network services, such as the multi-protocol infrastructure network devices described in this paper. A local infrastructure network device of a plurality of local infrastructure network devices can receive IoT device data over either or both a wired or a wireless connection used to provide an IoT device access to network services. For example, IoT device data can be received at a local infrastructure network device through a Wi-Fi connection established between an IoT device and the local infrastructure network device, wherein the local infrastructure network device provides network service access to the IoT device acting as a station.

The flowchart 200 continues to module 204, where load balancing is performed across the plurality of local infrastructure network devices for purposes of using fog networking to analyze the IoT device data using at least one of the plurality of local infrastructure network devices. In performing load balancing for purposes of using fog networking to analyze the IoT device data, the IoT device data can be kept at the local infrastructure network device that receives the IoT device data, where the IoT device data can subsequently be analyzed through fog networking. Alternatively, in performing load balancing for purposes of using fog networking to analyze the IoT device data, the IoT device data can be forwarded to a different local infrastructure network device of the plurality of local infrastructure network devices and subsequently analyzed at the different local infrastructure network device through fog networking. An applicable system for managing IoT device analytics using fog networking, such as the fog networking-based IoT device analytics systems described in this paper, can perform load balancing across the plurality of local infrastructure network devices for purposes of using fog networking to analyze the IoT device data.

The flowchart 200 continues to module 206, where the IoT device data is analyzed locally at the at least one plurality of local infrastructure network devices for purposes of using fog networking to analyze the IoT device data. An applicable system for managing IoT device analytics using fog networking, such as the fog networking-based IoT device analytics systems described in this paper, can analyze the IoT device data locally at the at least one of plurality of local infrastructure network devices. In analyzing the IoT device data for purposes of using fog networking to analyze the IoT device data, IoT device analytics data is generated. For example, if IoT device data is a captured video feed of a view within a store, then IoT device analytics data can be generated indicating traffic patterns of customers in the store, as determined from the IoT device data.

The flowchart 200 continues to module 208, where the IoT device analytics data is provided from the at least one of the plurality of local infrastructure network devices to a remote system as part of the analyzing of the IoT device data through fog networking. For example, the IoT device analytics data can be provided to a remote server implemented in the cloud, whereby a user can access the IoT device analytics data. An applicable system for managing IoT device analytics using fog networking, such as the fog networking-based IoT device analytics systems described in this paper, can provide the IoT device analytics data from the at least one of the plurality of local infrastructure network devices to a remote system as part of the analyzing of the IoT device data through fog networking. Additionally, portions of the IoT device data can be provided along with the IoT device analytics data from the at least one of the plurality of local infrastructure network devices to a remote system as part of the analyzing of the IoT device data through fog networking. In providing the IoT device analytics data and potentially only portions of the IoT device data absent transmission of all of the IoT device data to the remote system, network resource usage through an applicable network or combination of networks, e.g. a LAN, a WLAN, a consumer network, and an enterprise network, is reduced leading to decreased latency in providing IoT device access to network services.

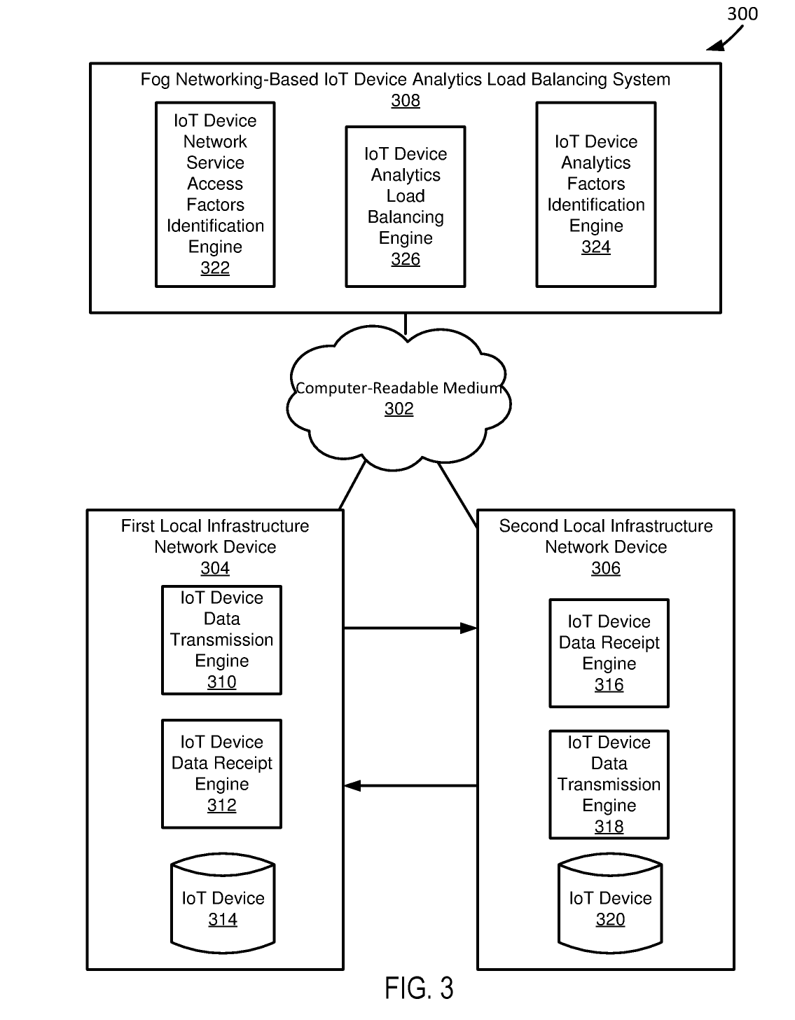

FIG. 3 depicts a diagram 300 of an example of a system for performing load balancing across local infrastructure network devices for purposes of analyzing IoT device data through fog networking. The example system shown in FIG. 3 includes a first local infrastructure network device 304, a second local infrastructure network device 306, and a fog networking-based IoT device analytics load balancing system 308. In the example system shown in FIG. 3, the first local infrastructure network device 304 and the second local infrastructure network device 306 are coupled to the fog networking-based IoT device analytics load balancing system 308 through the computer-readable medium 302. In being coupled to the first local infrastructure network device 304 and the second local infrastructure network device 306 through the computer-readable medium 302, all or portions of the fog networking-based IoT device analytics load balancing system 308 can be implemented at either or both the first local infrastructure network device 304 and the second local infrastructure network device 306. Further, in being coupled to the first local infrastructure network device 304 and the second local infrastructure network device 306, all or portions of the fog networking-based IoT device analytics load balancing system 308 can be implemented at a device remote from and coupled to the first and second local infrastructure network devices 304 and 306 through the computer-readable medium 302.

In the example system shown in FIG. 3, the first local infrastructure network device 304 and the second local infrastructure network device 306 are coupled to each other through the computer-readable medium 302. In coupling the first and second local infrastructure network devices 304 and 306 together, the computer-readable medium 302 can encompass either or both a wired or wireless connection. For example, the computer-readable medium 302 can include a wired LAN back-end coupling the first local infrastructure network device 304 to the second local infrastructure network device 306. In another example, the computer-readable medium 302 can include a wireless connection directly connecting the first local infrastructure network device 304 to the second local infrastructure network device 306 acting as mesh nodes in a wireless mesh network of local infrastructure network devices.

Referring back to the example system shown in FIG. 3, the first local infrastructure network device 304 and the second local infrastructure network device 306 are intended to represent devices that functions as local infrastructure network devices. The first local infrastructure network device 304 and the second local infrastructure network device 306 can be either or both an edge device and a forwarding device in one or a combination of a WLAN, a LAN, a consumer network, and an enterprise network. For example, either or both the first local infrastructure network device 304 and the second local infrastructure network device 306 can be applicable edge devices for forming a LAN with an IoT device and allowing the IoT device to access network services through the LAN, such as the multi-protocol infrastructure network devices described in this paper. In another example, either or both the first local infrastructure network device 304 and the second local infrastructure network device 306 can be forwarding devices configured to forward data to and from edge devices in providing network service access to IoT devices through the edge devices.

In a specific implementation, the first local infrastructure network device 304 and the second local infrastructure network device 306 are capable of receiving IoT device data generated by an IoT device for purposes of analyzing the IoT device data through fog networking. The first local infrastructure network device 304 and the second local infrastructure network device 306 can receive IoT device data generated by an IoT device as part of the IoT device accessing network services through a LAN using an applicable device, such as the multi-protocol infrastructure network devices described in this paper. For example, either or both the first local infrastructure network device 304 and the second local infrastructure network device 306 can act as multi-protocol infrastructure network devices by providing IoT devices access to network services through a LAN, and subsequently receive IoT device data from the IoT devices as part of providing the IoT devices access to network services.

In a specific implementation, the first local infrastructure network device 304 and the second local infrastructure network device 306 function to receive IoT device data from local infrastructure network devices. For example, the first local infrastructure network device 304 can act as a forwarding device within a LAN and receive IoT device data from an edge device of the LAN providing an IoT device access to network services. In another example, the first local infrastructure network device 304 can transmit IoT device data to the second local infrastructure network device 306 and vice versa.

In a specific implementation, the first local infrastructure network device 304 and the second local infrastructure network device 306 function to analyze IoT device data to generate IoT device analytics data. The first local infrastructure network device 304 and the second local infrastructure network device 306 can generate IoT device analytics data from IoT device data as part of analyzing the IoT device data through fog networking. IoT device data analyzed at the first local infrastructure network device 304 and the second local infrastructure network device 306 can be received and stored locally at the corresponding devices 304 and 306. For example, the second local infrastructure network device 306 can receive IoT device data from the first local infrastructure network device 304 and subsequently analyze the IoT device data to generate IoT device analytics data at the second local infrastructure network device 206.

In a specific implementation, the first local infrastructure network device 304 and the second local infrastructure network device 306 are capable of receiving IoT device analytics data as part of analyzing IoT device data through fog networking. The first local infrastructure network device 304 and the second local infrastructure network device 306 can receive IoT device analytics data from local infrastructure network devices. For example, the first local infrastructure network device 304 can generate IoT device analytics data and subsequently provide the IoT device analytics data to the second local infrastructure network device 306. Further in the example, the second local infrastructure network device 306 can either or both store the received IoT device analytics data locally, e.g. at the second local infrastructure network device 306, and provide the IoT device analytics data to a remote system, e.g. in the cloud, as part of analyzing IoT device data through fog networking.

In a specific implementation, either or both IoT device data and IoT device analytics data is transmitted to and from the first and second local infrastructure network devices 304 and 306 for purposes of load balancing across local infrastructure network devices in analyzing IoT device data through fog networking. For example, the first local infrastructure network device 304 can transmit IoT device data it receives to the second local infrastructure network device 306 if it is determined the second local infrastructure network device 306 should analyze the IoT device data for purposes of load balancing across local infrastructure network devices. In another example, the second local infrastructure network device 306 can transmit IoT device data it receives to the first local infrastructure network device 304 if it is determined the first local infrastructure network device has storage space to store the IoT device data for purposes of load balancing across local infrastructure network devices.

In a specific implementation, either or both IoT device data and IoT device analytics data is transmitted to and from the first and second local infrastructure network devices 304 and 306 for purposes of load balancing based on IoT device network service access through a LAN. Specifically, data can be transmitted to and from the first and second local infrastructure network devices 304 and 306 based on factors related to providing IoT devices network service access through local infrastructure devices. For example, if the first local infrastructure network device 304 is consuming 80% of its computational resources in providing IoT devices access to network services, then the first local infrastructure network device 304 can transmit IoT device data to the second local infrastructure network device 306 for purposes of load balancing across local infrastructure network devices. Further in the example, the second local infrastructure network device 306 can analyze the received IoT device data to generate IoT device analytics data as part of load balancing across local infrastructure network devices for analyzing IoT device data through fog networking. In another example, if the first local infrastructure network device 304 is providing network service access to a threshold number of IoT devices, then the first local infrastructure network device 304 can provide IoT device data to the second local infrastructure network device 306 as part of load balancing across local infrastructure network devices.

In a specific implementation, either or both IoT device data and IoT device analytics data is transmitted to and from the first and second local infrastructure network devices 304 and 306 for purposes of load balancing based on functioning of local infrastructure network devices to analyze IoT device data through fog networking. Specifically, data can be transmitted to and from the first and second local infrastructure network devices 304 and 306 based on factors related to analyzing IoT device data. For example, if the second local infrastructure network device 306 is assigned as a central IoT device data analysis device, then the first local infrastructure network device 304 can provide IoT device data to the second local infrastructure network device 306. Further in the example, the second local infrastructure network device 306 can subsequently function in its capacity as a central IoT device data analysis device by analyzing IoT device data received from the first local infrastructure network device 304.

In the example system shown in FIG. 3, the first local infrastructure network device 304 includes an IoT device data transmission engine 310, an IoT device data receipt engine 312, and an IoT device datastore 314. The IoT device data transmission engine 310, the IoT device data receipt engine 312, and the IoT device datastore 314 can be implemented as part of an applicable system for managing analysis of IoT device data through fog networking, such as the fog networking-based IoT device analytics systems described in this paper. The IoT device data transmission engine 310 is intended to represent an engine that functions to transmit either or both IoT device data and IoT device analytics data from the first local infrastructure network device 304. The IoT device data transmission engine 310 can transmit either or both IoT device data and IoT device analytics data from the first local infrastructure network device 304 to other local infrastructure network devices in one or a combination of a WLAN, a LAN, a consumer network, and an enterprise network. For example, the IoT device data transmission engine 310 can transmit either or both IoT device data and IoT device analytics data from the first local infrastructure network device 304 to a neighboring local infrastructure network device through a LAN back-end. Additionally, the IoT device data transmission engine 310 can transmit either or both IoT device data and IoT device analytics data as part of load balancing across local infrastructure network devices for purposes of analyzing IoT device data through fog networking.

The IoT device data receipt engine 312 is intended to represent an engine that functions to receive either or both IoT device data and IoT device analytics data at the first local infrastructure network device 304. The IoT device data receipt engine 312 can receive either or both IoT device data and IoT device analytics data at the first local infrastructure network device 304 from other local infrastructure network devices in one or a combination of a WLAN, a LAN, a consumer network, and an enterprise network. For example, the IoT device data receipt engine 312 can receive either or both IoT device data and IoT device analytics data at the first local infrastructure network device 304 from a neighboring local infrastructure network device through a LAN back-end. Additionally, the IoT device data receipt engine 312 can receive either or both IoT device data and IoT device analytics data as part of load balancing across local infrastructure network devices for purposes of analyzing IoT device data through fog networking.

The IoT device datastore 314 is intended to represent a datastore that functions to store either or both IoT device data and IoT device analytics data at the first local infrastructure network device 304. IoT device data and IoT device analytics data stored in the IoT device datastore 314 at the first local infrastructure network device 304 can be received from either or both another local infrastructure network device or directly from an IoT device through a LAN. Additionally IoT device data and IoT device analytics data stored in the IoT device datastore 314 at the first local infrastructure network device 304 can be received through load balancing across local infrastructure network devices for purposes of analyzing IoT device data through fog networking. IoT device data stored in the IoT device datastore 314 can be analyzed at the first local infrastructure network device 304 to generate IoT device analytics data through fog networking at the first local infrastructure network device 304.

In the example system shown in FIG. 3, the second local infrastructure network device 306 includes an IoT device data receipt engine 316, an IoT device data transmission engine 318, and an IoT device datastore 320. The IoT device data receipt engine 316, the IoT device data transmission engine 318, and the IoT device datastore 320 can be implemented as part of an applicable system for managing analysis of IoT device data through fog networking, such as the fog networking-based IoT device analytics systems described in this paper. The IoT device data receipt engine 316 is intended to represent an engine that functions to receive either or both IoT device data and IoT device analytics data at the second local infrastructure network device 306. The IoT device data receipt engine 316 can receive either or both IoT device data and IoT device analytics data at the second local infrastructure network device 306 from other local infrastructure network devices in one or a combination of a WLAN, a LAN, a consumer network, and an enterprise network. For example, the IoT device data receipt engine 316 can receive either or both IoT device data and IoT device analytics data at the second local infrastructure network device 306 from a neighboring local infrastructure network device through a LAN back-end. Additionally, the IoT device data receipt engine 316 can receive either or both IoT device data and IoT device analytics data as part of load balancing across local infrastructure network devices for purposes of analyzing IoT device data through fog networking.

The IoT device data transmission engine 318 is intended to represent an engine that functions to transmit either or both IoT device data and IoT device analytics data from the second local infrastructure network device 306. The IoT device data transmission engine 318 can transmit either or both IoT device data and IoT device analytics data from the second local infrastructure network device 306 to other local infrastructure network devices in one or a combination of a WLAN, a LAN, a consumer network, and an enterprise network. For example, the IoT device data transmission engine 318 can transmit either or both IoT device data and IoT device analytics data from the second local infrastructure network device 306 to a neighboring local infrastructure network device through a LAN back-end. Additionally, the IoT device data transmission engine 318 can transmit either or both IoT device data and IoT device analytics data as part of load balancing across local infrastructure network devices for purposes of analyzing IoT device data through fog networking.

The IoT device datastore 320 is intended to represent a datastore that functions to store either or both IoT device data and IoT device analytics data at the second local infrastructure network device 306. IoT device data and IoT device analytics data stored in the IoT device datastore 320 at the second local infrastructure network device 306 can be received from either or both another local infrastructure network device or directly from an IoT device through a LAN. Additionally IoT device data and IoT device analytics data stored in the IoT device datastore 320 at the second local infrastructure network device 306 can be received through load balancing across local infrastructure network devices for purposes of analyzing IoT device data through fog networking. IoT device data stored in the IoT device datastore 320 can be analyzed at the second local infrastructure network device 306 to generate IoT device analytics data through fog networking at the second local infrastructure network device 306.

Referring back to the example system shown in FIG. 3, the fog networking-based IoT device analytics load balancing system 308 is intended to represent a system that functions to manage load balancing across local infrastructure network devices for purposes of analyzing IoT device data through fog networking. In managing load balancing across local infrastructure network devices, the fog networking-based IoT device analytics load balancing system 308 can cause network devices to transmit either or both IoT device data and IoT device analytics data between each other. Additionally, in managing load balancing across local infrastructure network devices, the fog networking-based IoT device analytics load balancing system 308 can cause or otherwise instruct an infrastructure network device to analyze IoT device data through fog networking.

In a specific implementation, the fog networking-based IoT device analytics load balancing system 308 is implemented as part of an applicable system for managing analysis of IoT device data through fog networking, such as the fog networking-based IoT device analytic systems described in this paper. In being implemented as part of an applicable system for managing analysis of IoT device data through fog networking, the fog networking-based IoT device analytics load balancing system 308 can be implemented at one or across a plurality of local infrastructure network devices. For example, the fog networking-based IoT device analytics load balancing system 308 can be implemented across edge devices of a LAN.

In a specific implementation, the fog networking-based IoT device analytics load balancing system 308 functions to manage load balancing across local infrastructure network devices based on IoT device network service access through a LAN. Specifically, the fog networking-based IoT device analytics load balancing system 308 can manage load balancing across local infrastructure network devices based on factor related to providing IoT devices network service access through the local infrastructure network devices. For example, if a local infrastructure network device is consuming 80% of its computational resources in providing IoT devices access to network services, then the fog networking-based IoT device analytics load balancing system 308 can cause the local infrastructure network device to send IoT device data to another local infrastructure network device for purposes of load balancing across local infrastructure network devices. Further in the example, the fog networking-based IoT device analytics load balancing system 308 can instruct or otherwise cause the another local infrastructure network device to analyze the received IoT device data to generate IoT device analytics data as part of load balancing across local infrastructure network devices for purposes of analyzing IoT device data through fog networking.

In a specific implementation, the fog networking-based IoT device analytics load balancing system 308 functions to manage load balancing across local infrastructure network devices based on functioning of local infrastructure network devices to analyze IoT device data through fog networking. Specifically, the fog networking-based IoT device analytics load balancing system 308 can manage load balancing across local infrastructure network devices based on factors related to analyzing IoT device data. For example, if a local infrastructure network device is consuming 80% of its computational resources in analyzing IoT device data, then the fog networking-based IoT device analytics load balancing system 308 can cause the local infrastructure network device to send IoT device data to another local infrastructure network device for purposes of load balancing across local infrastructure network devices. Further in the example, the fog networking-based IoT device analytics load balancing system 308 can instruct or otherwise cause the another local infrastructure network device to analyze the received IoT device data to generate IoT device analytics data as part of load balancing across local infrastructure network devices for purposes of analyzing IoT device data through fog networking.

In the example system shown in FIG. 3, the fog networking-based IoT device analytics load balancing system 308 includes an IoT device network service access factors identification engine 322, an IoT device analytics factors identification engine 324, and an IoT device analytics load balancing engine 326. The IoT device network service access factors identification engine 322 is intended to represent an engine that functions to determine factors related to providing IoT devices network service access through local infrastructure network devices. For example, the IoT device network service access factors identification engine 322 can determine an amount of computational resources a local infrastructure network device is utilizing at any specific time in providing IoT devices access to network services through a LAN. In another example, the IoT device network service access factors identification engine 322 can determine an amount of local storage available at a local infrastructure network device. The IoT device network service access factors identification engine 322 can determine factors related to providing IoT devices network service access through local infrastructure network devices for any number of applicable infrastructure network devices across one or a combination of a WLAN, a LAN, a consumer network, and an enterprise network. For example, the IoT device network service access factors identification engine 322 can determine factors related to providing IoT device network service access across all multi-protocol infrastructure network devices forming part of a LAN.

The IoT device analytics factors identification engine 324 is intended to represent an engine that functions to determine factors related to analyzing IoT device data. For example, the IoT device analytics factors identification engine 324 can determine an amount of computational resources a local infrastructure network device is utilizing at any specific time in analyzing IoT device data through fog networking. In another example, the IoT device analytics factors identification engine 324 can determine whether a local infrastructure network device is assigned as a central IoT device data analysis device. The IoT device analytics factors identification engine 324 can determine factors related to analyzing IoT device data for any number of applicable infrastructure network devices across one or a combination of a WLAN, a LAN, a consumer network, and an enterprise network. For example, the IoT device analytics factors identification engine 324 can determine factors related to analyzing IoT device data across all multi-protocol infrastructure network devices forming part of a LAN.

The IoT device analytics load balancing engine 326 is intended to represent an engine that functions to perform load balancing across local infrastructure network devices for purposes of analyzing IoT device data through fog networking. In performing load balancing across local infrastructure network devices for purposes of analyzing IoT device data through fog networking, the IoT device analytics load balancing engine 326 can cause local infrastructure network devices to transmit either or both IoT device data and IoT device analytics data between each other. Further, in performing load balancing across local infrastructure network devices for purposes of analyzing IoT device data through fog networking, the IoT device analytics load balancing engine 326 can cause a local infrastructure network device to analyze IoT device data at the device to generate IoT device analytics data using fog networking.

In a specific implementation, the IoT device analytics load balancing engine 326 functions to manage load balancing across local infrastructure network devices based on factors related to providing IoT devices network service access through the local infrastructure network devices. For example, if a local infrastructure network device has only 20% of its local storage available, then the IoT device analytics load balancing engine 326 can cause the local infrastructure network device to send IoT device data to another local infrastructure network device for purposes of load balancing across local infrastructure network devices. Further in the example, the IoT device analytics load balancing engine 326 can instruct or otherwise cause the another local infrastructure network device to analyze the received IoT device data to generate IoT device analytics data as part of load balancing across local infrastructure network devices for purposes of analyzing IoT device data through fog networking.

In a specific implementation, the IoT device analytics load balancing engine 326 functions to manage load balancing across local infrastructure network devices based on factors related to analyzing IoT device data. For example, if a local infrastructure network device is consuming 80% of its computational resources in analyzing IoT device data, then the IoT device analytics load balancing engine 326 can cause the local infrastructure network device to send IoT device data to another local infrastructure network device for purposes of load balancing across local infrastructure network devices. Further in the example, the IoT device analytics load balancing engine 326 can instruct or otherwise cause the another local infrastructure network device to analyze the received IoT device data to generate IoT device analytics data as part of load balancing across local infrastructure network devices for purposes of analyzing IoT device data through fog networking.

In an example of operation of the example system shown in FIG. 3, the IoT device data receipt engine 312 receives at the first local infrastructure network device 304, IoT device data from an IoT device generated by an IoT device as part of the IoT device accessing network services. In the example of operation of the example system shown in FIG. 3, the IoT device network service access factors identification engine 322 determines factors related to providing IoT devices network service access of the first local infrastructure network device 304 and the second local infrastructure network device 306. Further, in the example of operation of the example system shown in FIG. 3, the IoT device analytics factors identification engine 324 determines factors related to analyzing IoT device data at the first local infrastructure network device 304 and the second local infrastructure network device 306. In the example of operation of the example system shown in FIG. 3, the IoT device analytics load balancing engine 326 manages load balancing of analyzing the IoT device data between the first local infrastructure network device 304 and the second local infrastructure network device in determining IoT device analytics data from the IoT device data through fog networking. Additionally, in the example of operation of the example system shown in FIG. 3, the IoT device analytics load balancing engine 326 uses the factors related to analyzing IoT device data and the factors related to providing IoT device network service access to manage load balancing between the first local infrastructure network device 304 and the second local infrastructure network device 306.

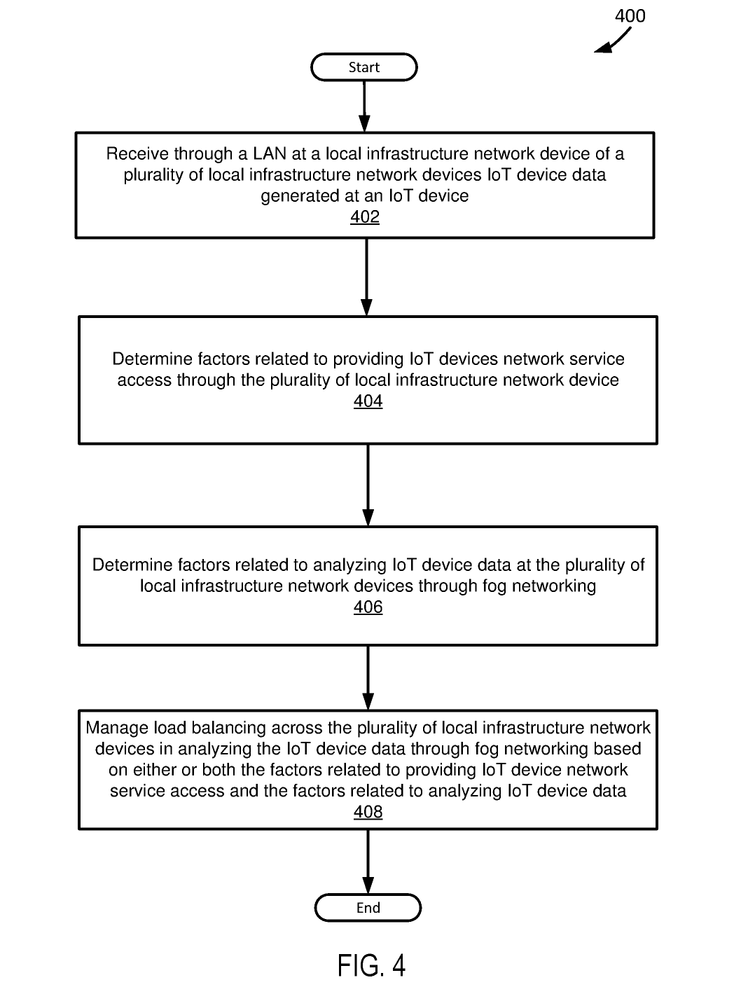

FIG. 4 depicts a flowchart 400 of an example of a method for performing load balancing between local infrastructure network devices for purposes of analyzing IoT device data through fog networking. The flowchart 400 begins at module 402, where IoT device data generated at an IoT device is received through a LAN at a local infrastructure network device of a plurality of local infrastructure network devices. An applicable engine for receiving IoT device data at a local infrastructure network device, such as the IoT device data reception engines can receive the IoT device at a local infrastructure network device of a plurality of infrastructure network devices. A local infrastructure network device of a plurality of local infrastructure network devices can receive IoT device data over either or both a wired or a wireless connection used to provide an IoT device access to network services. For example, IoT device data can be received at a local infrastructure network device through a Wi-Fi connection established between an IoT device and the local infrastructure network device, wherein the local infrastructure network device provides network service access to the IoT device acting as a station.

The flowchart 400 continues to module 404, where factors related to providing IoT devices network service access through the plurality of local infrastructure network devices are determined. An applicable engine for determining factors related to providing IoT devices network service access, such as the IoT device network service access factors identification engines described in this paper, can determine factors related to providing IoT devices network service access through the plurality of local infrastructure network devices. For example, it can be determined an amount of computational resources any number of the plurality of local infrastructure network devices are each using in providing network service access to IoT devices.

The flowchart 400 continues to module 406, where factors related to analyzing IoT device data through the plurality of local infrastructure network devices are determined. An applicable engine for determining factors related to analyzing IoT device data at local infrastructure network devices through fog networking, such as the IoT device analytics factors identification engines described in this paper, can determine factors related to analyzing IoT device data through the plurality of local infrastructure network devices. For example, an amount of local storage being used by a local infrastructure network device in analyzing IoT device data through fog networking can be determined.

The flowchart 400 continues to module 408, where load balancing across the plurality of local infrastructure network devices in analyzing the IoT device data through fog networking is managed based on either or both the factors related to providing IoT device network service access and the factors related to analyzing IoT device data. An applicable engine for managing load balancing across local infrastructure network devices in analyzing IoT device data through fog networking, such as the IoT device analytics load balancing engines described in this paper, can manage load balancing across the plurality of local infrastructure network devices in analyzing the IoT device data through fog networking based on either or both the factors related to providing IoT device network service access and the factors related to analyzing IoT device data. In managing load balancing across the plurality of local infrastructure network devices the local infrastructure network devices can be instructed or otherwise caused to transmit either or both the IoT device data and IoT device analytics data between each other. Further, in managing load balancing across the plurality of local infrastructure network devices, the local infrastructure network devices can be instructed or otherwise caused to generate IoT device analytics data from the IoT device data. Additionally, in managing load balancing across the plurality of local infrastructure network devices, the local infrastructure network devices can be instructed or otherwise caused to store either or both the IoT device data and IoT device analytics data locally.

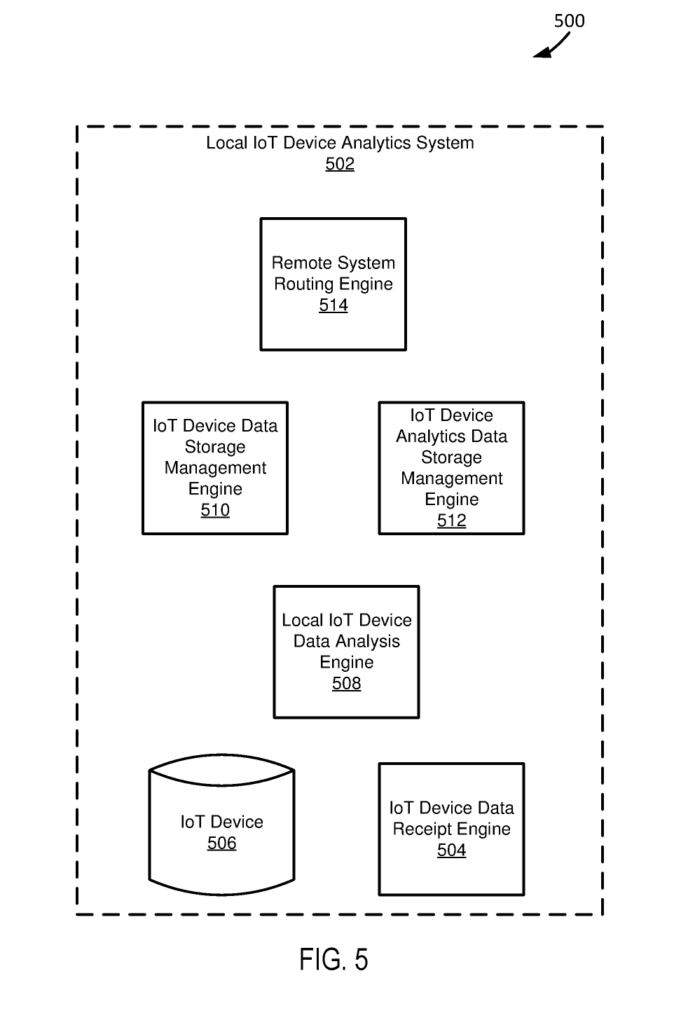

FIG. 5 depicts a diagram 500 of an example of a local IoT device analytics system 502. The local IoT device analytics system 502 is intended to represent a system that functions to manage local analysis of IoT device data at local infrastructure network devices as part of fog networking. In managing local analysis of IoT device data at local infrastructure network devices as part of fog networking, the local IoT device analytics system 502 can be implemented as part of an applicable system for managing analysis of IoT device data through fog networking, such as the fog networking-based IoT device analytics systems described in this paper. In being implemented as part of an applicable system for managing analysis of IoT device data through fog networking, the local IoT device analytics system 502 can be implemented, at least in part, at a local infrastructure network device. For example, the local IoT device analytics system 502 can be implemented at an applicable device for providing IoT devices network service access, such as the multi-protocol infrastructure network devices described in this paper.

In a specific implementation, in managing local analysis of IoT device data through fog networking at local infrastructure network devices, the local IoT device analytics system 502 functions to locally analyze IoT device data received at a local infrastructure network device to generate IoT device analytics data. For example, if a local infrastructure network device receives a video feed of a consumer in a store, then the local IoT device analytics system 502 can perform facial recognition on portions of the video feed to identify the consumer. Further in the example, the local IoT device analytics system 502 can subsequently generate IoT device analytics data indicating an identification of the consumer. The local IoT device analytics system 502 can locally analyze IoT device data in response to either or both receipt of IoT device data at a local infrastructure network device. For example, the local IoT device analytics system 502 can locally analyze IoT device data at a local infrastructure network device automatically in response to receipt of the IoT device data at the local infrastructure network device. Alternatively, the local IoT device analytics system 502 can locally analyze IoT device data in response to receipt of instructions from an applicable system for performing load balancing across local infrastructure network devices in analyzing IoT device data through fog networking, such as the fog networking-based IoT device analytics load balancing systems described in this paper.

In a specific implementation, in managing local analysis of IoT device data through fog networking at local infrastructure network devices, the local IoT device analytics system 502 functions to manage routing of either or both IoT device data and IoT device analytics data to a remote system. In managing routing of either or both IoT device data and IoT device analytics data to a remote system, the local IoT device analytics system 502 can transmit the data using an applicable data transport or messaging protocol. For example, the local IoT device analytics system 502 can use an applicable lightweight messaging protocol to transmit IoT device data and IoT device analytics data to a remote system. Further, in managing routing of either or both IoT device data and IoT device analytics data to a remote system, the local IoT device analytics system 502 can select specific IoT device data and IoT device analytics data to transmit to the remote system. For example, the local IoT device analytics system 502 can select a subset of IoT device data to transmit to a remote system while refraining from transmitting all of the IoT device data to the remote system.

In a specific implementation, the local IoT device analytics system 502 functions to route either or both IoT device data and IoT device analytics data to a remote system through application-based routing. Application-based routing can include one or a combination of selection of a remote system to transmit data to, tunnels or applicable routes to use in transmitting data, and protocols to use in transmitting data. For example if a remote system is configured to process IoT device analytics data generated for a specific type of IoT device, then the local IoT device analytics system 502 can route IoT device analytics data generated for an IoT device of the specific type to the remote system. In routing data through application-based routing, the local IoT device analytics system 502 can transmit data according to characteristics of IoT device operation. Characteristics of IoT device operation include applicable characteristics related to operation of an IoT device. For example, characteristics of IoT device operation can include an IoT device type, a user operating an IoT device, applications used in operation of an IoT device, and applications associated with operation of an IoT device in accessing network services.

In a specific implementation, in managing local analysis of IoT device data through fog networking at local infrastructure network devices, the local IoT device analytics system 502 functions to manage local storage of either or both IoT device data and IoT device analytics data at a local infrastructure network device. In managing local storage of either or both IoT device data and IoT device analytics data at a local infrastructure network device, the local IoT device analytics system 502 can determine whether to locally store IoT device data and IoT device analytics data and subsequently cause local storage of the data at a local infrastructure network device. For example, the local IoT device analytics system 502 can determine to store specific portions of IoT device data at a local infrastructure network device and subsequently cause storage of the specific portion of IoT device data at the local infrastructure network device. Further in managing local storage of either or both IoT device data and IoT device analytics data, the local IoT device analytics system 502 can remove data from local storage at a local infrastructure network device. For example, the local IoT device analytics system 502 can remove specific portions of IoT device data not used to generate IoT device analytics data from local storage at a local infrastructure network device. The local IoT device analytics system 502 can manage local storage of IoT device data and IoT device analytics data at a local infrastructure network device in response to instructions from an applicable system for performing load balancing across local infrastructure network devices in analyzing IoT device data through fog networking, such as the fog networking-based IoT device analytics load balancing systems described in this paper.

The local IoT device analytics system 502 shown in FIG. 5 includes an IoT device data receipt engine 504, an IoT device datastore 506, a local IoT device data analysis engine 508, an IoT device data storage management engine 510, an IoT device analytics data storage management engine 512, and a remote system routing engine 514. The IoT device data receipt engine 504 is intended to represent an engine that functions to receive IoT device data at a local infrastructure network device, such as the IoT device data receipt engines described in this paper. The IoT device data receipt engine 504 can receive IoT device data directly from an IoT device accessing network services. For example, the IoT device data receipt engine 504 can be implemented at a multi-protocol infrastructure network device providing an IoT device access to network services and receive from the IoT device as part of accessing the network services, IoT device data generated by the IoT device. Additionally, the IoT device data receipt engine 504 can receive IoT device data from other local infrastructure network devices. For example, the IoT device data receipt engine can be implemented at a forwarding device within a LAN and receive IoT device data from an edge device in the LAN providing access to network services to an IoT device through a WLAN. The IoT device data receipt engine 504 can receive IoT device data as part of load balancing across local infrastructure network device operating to analyze IoT device data through fog networking.

The IoT device datastore 506 is intended to represent a datastore that stores either or both IoT device data and IoT device analytics data, such as the IoT device datastores described in this paper. IoT device data stored in the IoT device datastore 506 can be stored as part of selective local storage of IoT device data at a local infrastructure network device at which the IoT device datastore 506 is implemented. Additionally, IoT device analytics data stored in the IoT device datastore 506 can be generated locally at a local infrastructure network device at which the IoT device datastore 506 is implemented.

The local IoT device data analysis engine 508 is intended to represent an engine that functions to locally analyze IoT device data through fog networking. The local IoT device data analysis engine 508 locally analyzes IoT device data through fog networking at a local infrastructure network device at which the local IoT device data analysis engine 508 is implemented, at least in part. In locally analyzing IoT device data through fog network at a local infrastructure network device, the local IoT device data analysis engine 508 can generate IoT device analytics data reflecting an analysis of the IoT device information. For example, the local IoT device data analysis engine 508 can generate a consumer traffic map, as indicated by IoT device analytics data, from a video feed, as indicated by IoT device data, captured and received from a camera in a store. The local IoT device data analysis engine 508 can analyze IoT device in response to either or both receipt of the IoT device and receipt of instructions from an applicable system for managing load balancing of local infrastructure network devices for analyzing IoT device data through fog networking, such as the fog networking-based IoT device analytics load balancing systems described in this paper. For example, the local IoT device data analysis engine 508 can analyze IoT device data in automatically in response to receiving the IoT device data at a local infrastructure network device at which the local IoT device data analysis engine 508 is implemented. Additionally, the local IoT device data analysis engine 508 can analyze IoT device data as part of load balancing across local infrastructure network devices for analyzing IoT device data through fog networking.

In a specific implementation, the local IoT device data analysis engine 508 functions to analyze IoT device data according to characteristics of IoT device operation. In analyzing IoT device data according to characteristics of IoT device operation, the local IoT device data analysis engine 508 can determine the characteristics of IoT device operation. For example, the local IoT device data analysis engine 508 can determine a type of IoT device that generated specific IoT device data to be analyzed. Further, in analyzing IoT device data according to characteristics of IoT device operation, the local IoT device data analysis engine 508 can analyze the IoT device data based on a format of content of the IoT device data. For example, if specific rules and methods are uniquely used to analyze IoT device data content of a specific type, then the local IoT device data analysis engine 508 can analyze IoT device data content of the specific type using the specific methods and according to the specific rules. Further, in analyzing IoT device data according to characteristics of IoT device operation, the local IoT device data analysis engine 508 can analyze the IoT device based on either or both a type of IoT device used to generate IoT device data and an application used to generated the IoT device data. For example, if a camera generates IoT device data, then the local IoT device data analysis engine 508 can use applicable image processing techniques to analyze the IoT device data.

Returning back to the example local IoT device analytics system 502 shown in FIG. 5, the IoT device data storage management engine 510 is intended to represent an engine that functions to manage storage of IoT device data at a local infrastructure network device. In managing storage of IoT device data at a local infrastructure network device, the IoT device data storage management engine 510 can select specific IoT device data to store at the device and subsequently store the specific IoT device data at the local infrastructure network device. For example, the IoT device data storage management engine 510 can select and subsequently store only IoT device data that is analyzed in creating IoT device data through fog networking. The IoT device data storage management engine 510 can store IoT device data locally at a local infrastructure network device as part of load balancing of local network devices in analyzing IoT device data through fog networking. For example, the IoT device data storage management engine 510 can store specific IoT device data at a local infrastructure network device in response to instructions received from an applicable system for managing load balancing of local infrastructure network devices for analyzing IoT device data through fog networking, such as the fog networking-based IoT device analytics load balancing systems described in this paper.

In a specific implementation, in managing storage of IoT device data at a local infrastructure network device, the IoT device data storage management engine 510 functions to remove IoT device data from storage at the network device as part of selective local storage. For example, the IoT device data storage management engine 510 can remove IoT device data from local storage at a local infrastructure network device if the IoT device data is no longer being used to generate IoT device analytics data. The IoT device data storage management engine 510 can remove IoT device data from storage at a local infrastructure network device as part of load balancing of local infrastructure network devices for analyzing IoT device data through fog network. For example, the IoT device data storage management engine 510 can remove IoT device data from local storage at a local infrastructure network device based on instructions received from an applicable system for managing load balancing of local infrastructure network devices for analyzing IoT device data through fog networking, such as the fog networking-based IoT device analytics load balancing systems described in this paper.

Referring back to the local IoT device analytics system 502 shown in FIG. 5, the IoT device analytics data storage management engine 512 is intended to represent an engine that functions to manage storage of IoT device analytics data at a local infrastructure network device. In managing storage of IoT analytics device data at a local infrastructure network device, the IoT device analytics data storage management engine 512 can select specific IoT device analytics data to store at the device and subsequently store the specific IoT device analytics data at the local infrastructure network device. For example, the IoT device analytics data storage management engine 512 can select and subsequently store only IoT device analytics data that is or will be sent to a remote system as part of fog networking. The IoT device analytics data storage management engine 512 can store IoT device analytics data locally at a local infrastructure network device as part of load balancing of local network devices in analyzing IoT device data through fog networking. For example, the IoT device analytics data storage management engine 512 can store specific IoT device analytics data at a local infrastructure network device in response to instructions received from an applicable system for managing load balancing of local infrastructure network devices for analyzing IoT device data through fog networking, such as the fog networking-based IoT device analytics load balancing systems described in this paper.

In a specific implementation, in managing storage of IoT device analytics data at a local infrastructure network device, the IoT device analytics data storage management engine 512 functions to remove IoT device analytics data from storage at the network device as part of selective local storage. For example, the IoT device analytics data storage management engine 512 can remove IoT device analytics data from local storage at a local infrastructure network device after the IoT device analytics data is sent to a remote system. The IoT device analytics data storage management engine 512 can remove IoT device analytics data from storage at a local infrastructure network device as part of load balancing of local infrastructure network devices for analyzing IoT device data through fog network. For example, the IoT device analytics data storage management engine 512 can remove IoT device analytics data from local storage at a local infrastructure network device based on instructions received from an applicable system for managing load balancing of local infrastructure network devices for analyzing IoT device data through fog networking, such as the fog networking-based IoT device analytics load balancing systems described in this paper.

Referring back to the example local IoT device analytics system 502 shown in FIG. 5, the remote system routing engine 514 is intended to represent a system that functions to transmit either or both IoT device data and IoT device analytics data to a remote system. The remote system routing engine 514 can transmit IoT device data and IoT device analytics data as part of analysis of IoT device data through fog networking. In transmitting either or both IoT device data and IoT device analytics data to a remote system, the remote system routing engine 514 can select specific data to transmit and subsequently transmit the data. For example, the remote system routing engine 514 can select a specific subset of IoT device data to transmit to a remote system and subsequently transmit the specific subset of IoT device data to the remote system. The remote system routing engine 514 can transmit either or both IoT device data and IoT device analytics data to a remote system using an applicable data transport or messaging protocol. For example, the remote system routing engine 514 can transmit IoT device analytics data to a remote system according to the MQTT protocol.

In a specific implementation, the remote system routing engine 514 functions to transmit either or both IoT device data and IoT device analytics data to a remote system using application-based routing. In using application-based routing to transmit either or both IoT device data and IoT device analytics data to a remote system, the remote system routing engine 514 can transmit the data based on characteristics of IoT device operation. For example, if IoT device data was generated by a specific type of IoT device, and a specific remote system is configured to process data for the specific type of IoT devices, then the remote system routing engine 514 can transmit IoT device analytics data generated from the IoT device data to the specific remote system. In another example, if IoT device analytics data is generated based on a specific application executing at an IoT device, and a specific remote system is configured to process data of the specific application, then the remote system routing engine 514 can transmit the IoT device analytics data to the specific remote system. In transmitting data based on characteristics of IoT device operation, the remote system routing engine 514 can determine the characteristics of the IoT device operation.

In an example of operation of the example local IoT device analytics system 502 shown in FIG. 5, the IoT device data receipt engine 504 receives, at a local infrastructure network device, IoT device data generated by an IoT device as part of the IoT device accessing network services through a LAN. In the example of operation of the example system shown in FIG. 5, the local IoT device data analysis engine 508 determines characteristics of the IoT device in operating to generate the IoT device data. Further, in the example of operation of the example system shown in FIG. 5, the local IoT device data analysis engine 508 analyzes the IoT device data based on the characteristics of the IoT device in operating to generate the IoT device data to generate IoT device analytics data.

In the example of operation of the example system shown in FIG. 5, the IoT device data storage management engine 510 manages local storage of the received IoT device data in the IoT device datastore 506 at the local infrastructure network device. Additionally, in the example of operation of the example system shown in FIG. 5, the IoT device analytics data storage management engine 512 manages local storage of the generated IoT device analytics data in the IoT device datastore 506 at the local infrastructure network device. In the example of operation of the example system shown in FIG. 5, the remote system routing engine 514 transmits either or both portions of the IoT device data and the IoT device analytics data to a remote system.

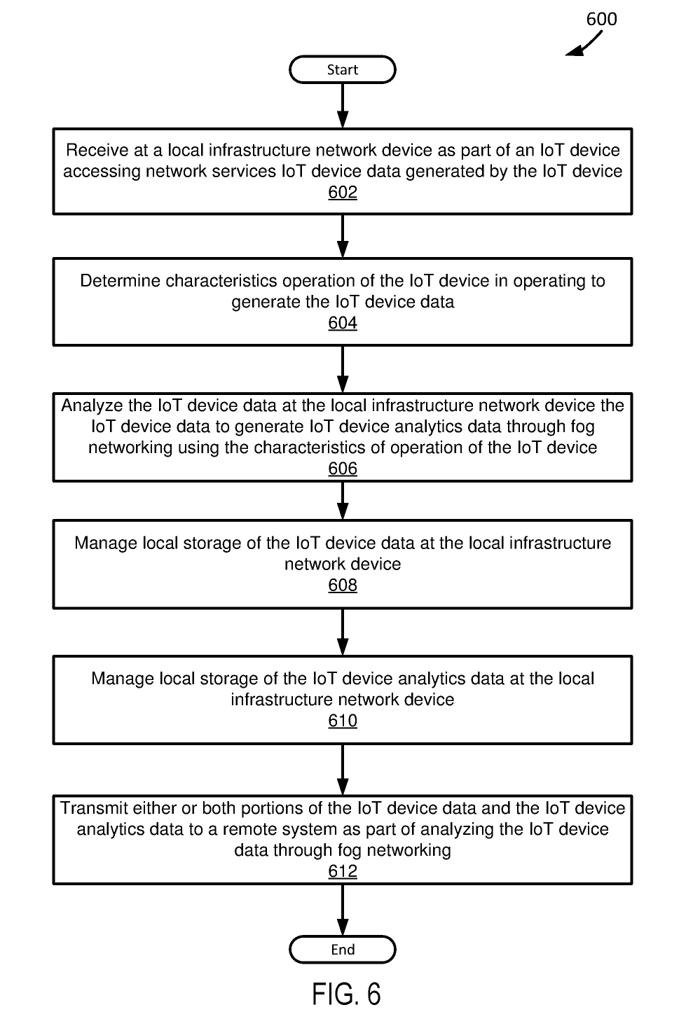

FIG. 6 depicts a flowchart 600 of an example of a method for analyzing IoT device data through fog networking at a local infrastructure network device. The flowchart 600 begins at module 602, where IoT device data generated by an IoT device is received at a local infrastructure network device as part of the IoT device accessing network services. An applicable engine for receiving IoT device data, such as the IoT device data receipt engines described in this paper, can receive, as part of an IoT device accessing network services, IoT device data generated at the IoT device. IoT device data can be received at a local infrastructure network device directly from an IoT device that generates the IoT device data or another local infrastructure network device. For example, IoT device data can be received at a local infrastructure network device as part of load balancing across a plurality of network devices to analyze IoT device data through fog networking. IoT device data can be received at a local infrastructure network device functioning as an applicable device for providing an IoT device network service access through a LAN, such as the multi-protocol infrastructure network devices described in this paper.

The flowchart 600 continues to module 604, where characteristics of operation of the IoT device in operating to generate the IoT device data are determined. An applicable engine for determining characteristics of IoT device operation, such as either or both the local IoT device data analysis engines and the remote system routing engines described in this paper, can determine characteristics of the IoT device in operating to generate the IoT device data. For example, an IoT device type of the IoT device that generated the IoT device data can be determined. In another example, an application used to generate the IoT device data at the IoT device can be determined.

The flowchart 600 continues to module 606, where the IoT device data is analyzed at the local infrastructure network device to generate IoT device analytics data through fog networking using the characteristics of operation of the IoT device. An applicable engine for analyzing IoT device data through fog networking, such as the local IoT device data analysis engines described in this paper, can analyze the IoT device data at the local infrastructure network device to generate IoT device analytics data through fog networking using the characteristics of operation of the IoT device. For example, if a specific type of IoT device data is generated by the IoT device, as indicated by the characteristics of operation of the IoT device, then rules specific to analyzing the specific type of IoT device data can be applied in analyzing the IoT device data to generate IoT device analytics data at the local infrastructure network device.

The flowchart 600 continues to module 608, where local storage of the IoT device data at the local infrastructure network device is managed. An applicable engine for managing local storage of IoT device data at a local infrastructure network device, such as the IoT device data storage management engines described in this paper, can manage local storage of the IoT device data at the local infrastructure network device. Local storage of the IoT device data at the local infrastructure network device can be managed as part of load balancing in analyzing IoT device data through fog networking. For example, IoT device data can be stored locally at the local infrastructure network device based on instructions received from an applicable system for managing load balancing across local infrastructure network devices in analyzing IoT device data through fog networking, such as the fog networking-based IoT device analytics load balancing systems described in this paper.

The flowchart 600 continues to module 610, where local storage of the IoT device analytics data at the local infrastructure network device is managed. An applicable engine for managing local storage of IoT device analytics data at a local infrastructure network device, such as the IoT device analytics data storage management engines described in this paper, can manage local storage of the IoT device analytics data at the local infrastructure network device. Local storage of the IoT device analytics data at the local infrastructure network device can be managed as part of load balancing in analyzing IoT device data through fog networking. For example, IoT device analytics data can be stored locally at the local infrastructure network device based on instructions received from an applicable system for managing load balancing across local infrastructure network devices in analyzing IoT device data through fog networking, such as the fog networking-based IoT device analytics load balancing systems described in this paper.

The flowchart 600 continues to module 612, where either or both portions of the IoT device data and the IoT device analytics data are transmitted to a remote system as part of analyzing the IoT device data through fog networking. An applicable engine for transmitting data to a remote system as part of analyzing IoT device data through fog networking, such as the remote system routing engines described in this paper, can transmit either or both portions of the IoT device data and the IoT device analytics data to a remote system as part of analyzing the IoT device data through fog networking. Either or both portions of the IoT device data and the IoT device analytics data can be transmitted to a remote system using application-based routing according to the characteristics of operation of the IoT device.

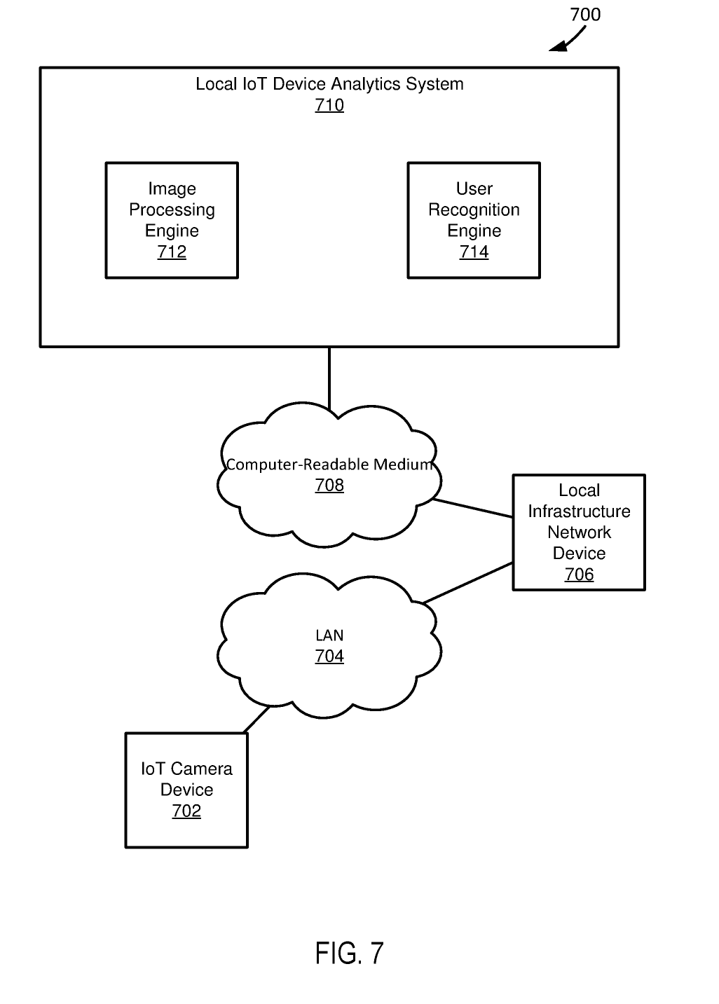

FIG. 7 depicts a diagram 700 of an example of a system for analyzing IoT device data generated by an IoT camera device through fog networking. The example system shown in FIG. 7 includes an IoT camera device 702, a LAN 704, a local infrastructure network device 706, a computer-readable medium 708, and a local IoT device analytics system 710. The IoT camera device 702 is intended to represent a device that functions to capture media capable of being perceived by a user either before or after processing of data generated by the IoT camera device 702. For example, the IoT camera device 702 can be a camera configured to capture a live feed of a plurality of images capable of being perceived by a human. The IoT camera device 702 can be positioned with respect to a device configured to provide IoT devices access to network services through a network, such as the multi-protocol infrastructure network devices described in this paper. The IoT camera device 702 can generate camera data, as included as part of IoT device data. Camera data includes data that can be used to reproduce media in a form capable of being perceived by a human.

In the example system shown in FIG. 7, the IoT camera device 702 is coupled to the local infrastructure network device 706 through a LAN 704. The LAN 704 can include either or both a wired and wireless connection coupling the local infrastructure network device 106 to the IoT camera device 702. For example the LAN 704 can include a wireless connection established through Wi-Fi and coupling the IoT camera device 702 to the local infrastructure network device 706. In another example, the LAN 704 can include a wired USB connection coupling the IoT camera device 702 to the local infrastructure network device 706.

The local infrastructure network device 706 is intended to represent a device that functions to facilitate providing of network service access to IoT devices. The local infrastructure network device 706 can be either or both an edge device or a forwarding device. For example, the local infrastructure network device 706 can be an edge device configured to provide IoT devices access to network services, such as the multi-protocol infrastructure network devices described in this paper. In another example, the local infrastructure network device 706 can be a forwarding device integrated as part of a LAN back-end and configured to forward data used in providing IoT devices network service access. The local infrastructure network device 706 can receive camera data generated by the IoT camera device 702 as part of the IoT camera device 702 accessing network services. For example, the local infrastructure network device 706 can receive camera data of a video captured by the IoT camera device 702 through the LAN 108, as part of the IoT camera device 702 accessing network services through the LAN 108.

The local IoT device analytics system 710 is coupled to the local infrastructure network device 706 through the computer-readable medium 708. The local IoT device analytics system 710 is intended to represent a system that functions to analyze IoT device data through fog networking, such as the local IoT device analytics systems described in this paper. The local infrastructure network device 706 can be implemented as part of, or otherwise at, the local infrastructure network device 706, for purposes of analyzing IoT device data at the local infrastructure network device 706 through fog networking.

In the example system shown in FIG. 7, the local IoT device analytics system 710 includes an image processing engine 712 and a user recognition engine 714. The image processing engine 712 is intended to represent an engine that functions to process images in camera data captured by an IoT camera device. In processing images in camera data captured by an IoT camera device, the image processing engine 712 can perform pre-processing on camera data, as included as part of IoT device data received from an IoT camera device. Pre-processed data generated by the image processing engine 712 can be included as part of IoT device data analytics data generated through fog networking and subsequently provided to a remote system as part of analyzing IoT device data through fog networking.

The user recognition engine 714 is intended to represent an engine that functions to recognize identifications of users from camera data, whether it is pre-pre-processed or not. For example, the user recognition engine 714 can recognize identifications of users in either or both camera data or pre-processed camera data. Identifications of users recognized by the user recognition engine 714 can be represented by IoT device analytics data. Additionally, identifications of users recognized by the user recognition engine 714 can be used to identify a device utilized by a user, potentially for providing the user access to network services through the device. For example, an identification of a user recognized by the user recognition engine 714 can be used to identify an identification of a device used by the user absent use of a MAC address of a device that potentially changes.

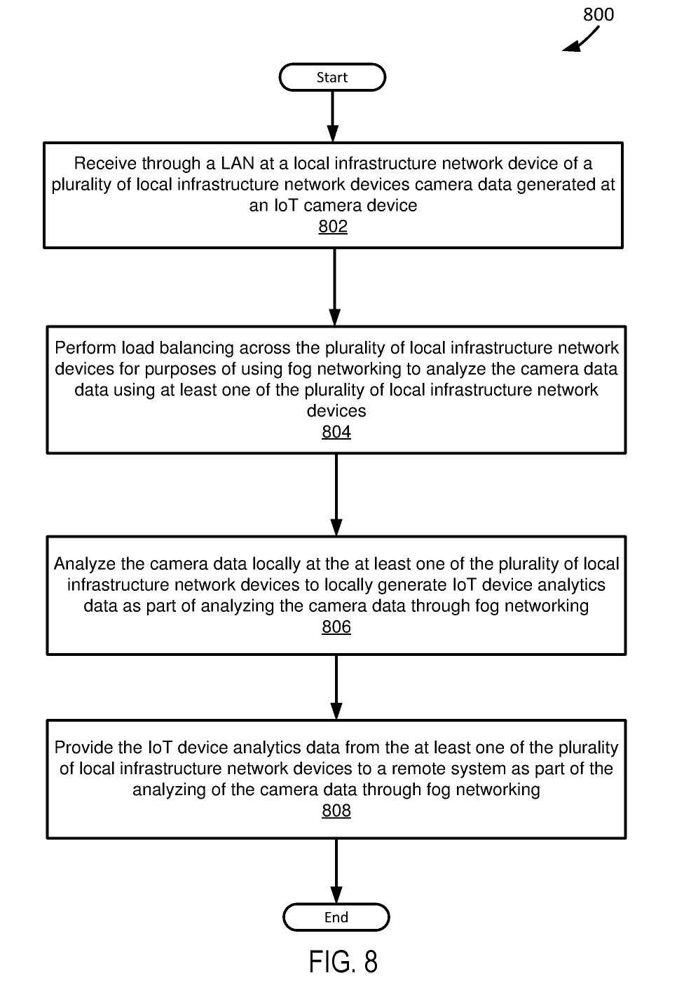

FIG. 8 depicts a flowchart 800 of an example of a method for analyzing camera data at a local infrastructure network device through fog networking. The flowchart 800 begins at module 802, where camera data generate at an IoT camera device is received at a local infrastructure network device of a plurality of infrastructure network devices through a LAN as part of the IoT camera device accessing network services using the LAN. An applicable engine for receiving IoT device data at a local infrastructure network device, such as the IoT device data receipt engines described in this paper. A local infrastructure network device receiving the camera data can be either or both an edge device of a LAN and a forwarding device of a LAN. For example, a local infrastructure network device receiving the camera data can be a multi-protocol infrastructure network device at an edge of a LAN and configured to provide network service access to IoT devices through the LAN. In another example, a local infrastructure network device received the camera data can be a device forming part of a back-end of a LAN used in providing IoT devices network service access.

The flowchart 800 continues to module 804, where load balancing is performed across the plurality of local infrastructure network devices for purposes of using fog networking to analyze the camera data using at least one of the plurality of local infrastructure network devices. An applicable system for managing load balancing across local infrastructure network devices for purposes of analyzing IoT device data through fog networking, such as the fog networking-based IoT device analytics load balancing systems described in this paper, can perform load balancing across the plurality of local infrastructure network device for purposes of using fog networking to analyze the camera data at the at least one of the plurality of local infrastructure network devices. For example, the camera data can be sent from the local infrastructure network device to another local infrastructure network device of the plurality of local infrastructure network devices for purposes of analyzing the camera data at the another local infrastructure network device through fog networking. In another example, the camera data can be kept at the local infrastructure network device through load balancing for purposes of analyzing the camera data at the local infrastructure network device through fog networking.

The flowchart 800 continues to module 806, where the camera data is analyzed at the at least one of the plurality of local infrastructure network devices to generate IoT device analytics data as part of analyzing the camera data through fog networking. An applicable system for analyzing IoT device through fog networking at local infrastructure network devices, such as the local IoT device analytics systems described in this paper, can analyze the camera data locally at the at least one of the plurality of local infrastructure network devices to locally generate IoT device analytics data as part of analyzing the camera data through fog networking at the at least one of the plurality of local infrastructure network devices. For example, the camera data can be pre-processed at the at least one of the plurality of local infrastructure network devices to local generate IoT device analytics data as part of analyzing the camera data through fog networking. In another example, the camera data can be analyzed to recognize identities of users in images included as part of the camera data to generate IoT device analytics data indicating the identities of the users.

The flowchart 800 continues to module 808, where the IoT device analytics data is provided from the at least one of the plurality of local infrastructure network devices to a remote system as part of the analyzing of the camera data through fog networking. An applicable engine for transmitting either or both IoT device data and IoT device analytics data to a remote system, such as the remote system routing engines described in this paper, can provide the IoT device analytics data from the at least one of the plurality of local infrastructure network devices to a remote system as part of the analyzing of the camera data through fog networking. The IoT device analytics data can be provided to a remote system through an applicable data transfer or messaging protocol. For example, the IoT device analytics data can be transmitted to a remote system using a light weight messaging protocol.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
receiving IoT device data generated by an IoT device in operation through a LAN at a local infrastructure network device of a plurality of local infrastructure network devices, the IoT device data received as part of the IoT device accessing network services through the LAN;
performing load balancing across the plurality of local infrastructure network devices for purposes of using fog networking to analyze the IoT device data using at least one of the plurality of local infrastructure network devices;
analyzing the IoT device data at the at least one of the plurality of local infrastructure network devices to locally generate IoT device data as part of analyzing the IoT device data through fog networking;
providing the IoT device analytics data generated at the at least one of the plurality of local infrastructure network devices from the at least one of the plurality of local infrastructure network devices to a remote system as part of analyzing the IoT device data through fog networking.

2. The method of claim 1, wherein the at least one of the plurality of local infrastructure network devices includes the local infrastructure network device of the plurality of local network devices that receives the IoT device data and the IoT device data is analyzed locally at the local infrastructure network device to generate the IoT device analytics data through fog networking.

3. The method of claim 1, wherein the local infrastructure network device is a multi-protocol infrastructure network device configured to provide access to network services to IoT devices acting as stations through a WLAN and the at least one of the plurality of local infrastructure network devices includes the local infrastructure network device of the plurality of local network devices that receives the IoT device data and the IoT device data is analyzed locally at the local infrastructure network device to generate the IoT device analytics data through fog networking.

4. The method of claim 1, wherein the local infrastructure network device is a forwarding device forming part of a back-end of the LAN and the at least one of the plurality of local infrastructure network devices includes the local infrastructure network device of the plurality of local network devices that receives the IoT device data and the IoT device data is analyzed locally at the local infrastructure network device to generate the IoT device analytics data through fog networking.

5. The method of claim 1, further comprising:
determining factors related to the plurality of local infrastructure network devices providing IoT devices including the IoT device network services access through the LAN;
performing load balancing across the plurality of local infrastructure network devices for purposes of using fog networking to analyze the IoT device data using the plurality of local infrastructure network devices based on the factors related to the plurality of local infrastructure network devices providing the IoT devices network service access through the LAN.

6. The method of claim 1, further comprising:
determining factors related to the plurality of local infrastructure network devices analyzing a plurality of IoT device data through fog networking;
performing load balancing across the plurality of local infrastructure network devices for purposes of using fog networking to analyze the IoT device data using the plurality of local infrastructure network devices based on the factors related to the plurality of local infrastructure network devices analyzing a plurality of IoT device data through fog networking.

7. The method of claim 1, further comprising:
determining characteristics of the IoT device in operation to generate the IoT device data;
analyzing the IoT device data at the at least one of the plurality of local infrastructure network device as part of analyzing the IoT device data through fog networking based on the characteristics of the IoT device in operation to generate the IoT device data.

8. The method of claim 1, further comprising transmitting the IoT device analytics data from the at least one of the plurality of local infrastructure network devices to the remote system through application-based routing.

9. The method of claim 1, further comprising:
determining characteristics of the IoT device in operation to generate the IoT device data;
transmitting the IoT device analytics data from the at least one of the plurality of local infrastructure network device to the remote system through application-based routing using the characteristics of the IoT device in operation to generate the IoT device data.

10. The method of claim 1, wherein the IoT device includes an IoT camera device and the IoT device data includes camera data of images captured by the IoT camera device.

11. A system comprising:
an IoT device data receipt engine configured to receive IoT device data generated by an IoT device in operation through a LAN at a local infrastructure network device of a plurality of local infrastructure network devices, the IoT device data received as part of the IoT device accessing network services through the LAN;
an IoT device analytics load balancing engine configured to perform load balancing across the plurality of local infrastructure network devices for purposes of using fog networking to analyze the IoT device data using at least one of the plurality of local infrastructure network devices;
a local IoT device data analysis engine configured to analyze the IoT device data at the at least one of the plurality of local infrastructure network devices to locally generate IoT device data as part of analyzing the IoT device data through fog networking;
a remote system routing engine configured to provide the IoT device analytics data generated at the at least one of the plurality of local infrastructure network devices from the at least one of the plurality of local infrastructure network devices to a remote system as part of analyzing the IoT device data through fog networking.

12. The system of claim 11, wherein the at least one of the plurality of local infrastructure network devices includes the local infrastructure network device of the plurality of local network devices that receives the IoT device data and the IoT device data is analyzed locally at the local infrastructure network device to generate the IoT device analytics data through fog networking.

13. The system of claim 11, wherein the local infrastructure network device is a multi-protocol infrastructure network device configured to provide access to network services to IoT devices acting as stations through a WLAN and the at least one of the plurality of local infrastructure network devices includes the local infrastructure network device of the plurality of local network devices that receives the IoT device data and the IoT device data is analyzed locally at the local infrastructure network device to generate the IoT device analytics data through fog networking.

14. The system of claim 11, wherein the local infrastructure network device is a forwarding device forming part of a back-end of the LAN and the at least one of the plurality of local infrastructure network devices includes the local infrastructure network device of the plurality of local network devices that receives the IoT device data and the IoT device data is analyzed locally at the local infrastructure network device to generate the IoT device analytics data through fog networking.

15. The system of claim 11, further comprising:
an IoT device network service access factors identification engine configured to determine factors related to the plurality of local infrastructure network devices providing IoT devices including the IoT device network services access through the LAN;
the IoT device analytics load balancing engine further configured to perform load balancing across the plurality of local infrastructure network devices for purposes of using fog networking to analyze the IoT device data using the plurality of local infrastructure network devices based on the factors related to the plurality of local infrastructure network devices providing the IoT devices network service access through the LAN.

16. The system of claim 11, further comprising:
an IoT device analytics factors identification engine configured to determine factors related to the plurality of local infrastructure network devices analyzing a plurality of IoT device data through fog networking;
the IoT device analytics load balancing engine further configured to perform load balancing across the plurality of local infrastructure network devices for purposes of using fog networking to analyze the IoT device data using the plurality of local infrastructure network devices based on the factors related to the plurality of local infrastructure network devices analyzing a plurality of IoT device data through fog networking.

17. The system of claim 11, wherein the local IoT device data analytics engine is further configured to:
determine characteristics of the IoT device in operation to generate the IoT device data;
analyze the IoT device data at the at least one of the plurality of local infrastructure network device as part of analyzing the IoT device data through fog networking based on the characteristics of the IoT device in operation to generate the IoT device data.

18. The system of claim 11, wherein the remote system routing engine is further configured to:
determine characteristics of the IoT device in operation to generate the IoT device data;
transmit the IoT device analytics data from the at least one of the plurality of local infrastructure network device to the remote system through application-based routing using the characteristics of the IoT device in operation to generate the IoT device data.

19. The system of claim 11, wherein the IoT device includes an IoT camera device and the IoT device data includes camera data of images captured by the IoT camera device.

20. A system comprising:
means for receiving IoT device data generated by an IoT device in operation through a LAN at a local infrastructure network device of a plurality of local infrastructure network devices, the IoT device data received as part of the IoT device accessing network services through the LAN;
means for performing load balancing across the plurality of local infrastructure network devices for purposes of using fog networking to analyze the IoT device data using at least one of the plurality of local infrastructure network devices;
means for analyzing the IoT device data at the at least one of the plurality of local infrastructure network devices to locally generate IoT device data as part of analyzing the IoT device data through fog networking;
means for providing the IoT device analytics data generated at the at least one of the plurality of local infrastructure network devices from the at least one of the plurality of local infrastructure network devices to a remote system as part of analyzing the IoT device data through fog networking.
